(19) United States
(12) Patent Application Publication
(10) Pub. No.: US 2006/0111894 A1
(43) Pub. Date: May 25, 2006

(54) Method and system for communication prioritization

(75) Inventors: John R. Sammarco, Great Falls, VA (US); Thaddeus A. Bielawa III, Ashburn, VA (US)

Correspondence Address: POSZ LAW GROUP, PLC, 12040 SOUTH LAKES DRIVE, SUITE 101, RESTON, VA, 20191, US

(73) Assignee: DEFINITIVE BUSINESS SOLUTIONS, LLC

(21) Appl. No.: 11/280,349

(22) Filed: Nov. 17, 2005

Related U.S. Application Data
(60) Provisional application No. 60/628,953, filed on Nov. 19, 2004.

(51) Int. Cl. G06F 17/27

(52) U.S. Cl. 704/9

(57) ABSTRACT

A computer system for managing workflow relating to a topic shared among a team of users includes a creation unit (109a, 109b, 109c). The creation unit (109a, 109b, 109c) facilitates creating topics (103) and assigning a priority to each of the topics. A topic assignment unit (111a, 111b, 111c) facilitates tasking a topic to an owner, and associating the topic with a team, the owner and the originator being members of the team. A communication production unit (113a, 113b, 113c) facilitates producing communications (101) responsive to the topic and automatically associated with the topic. The communication (101) is initiated by a team member, assigned an urgency reflecting a deadline and an importance selected by the team member, and automatically associated with the priority assigned to the topic. A ranking (115a, 115b, 115c) of the communication relative to the other communications can be automatically calculated

### RELATED APPLICATIONS

This application claims priority to U.S. Provisional Patent Application No. 60/628,953, filed Nov. 19, 2004, which is expressly incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates in general to electronic messaging, and more specifically to prioritizing electronic communications.

2. Description of the Related Art

Project-driven enterprises face incredible challenges today. Regulatory agencies are demanding more information, more disclosure, and more accountability, all with shorter reporting periods. Stakeholders are expecting higher returns on technology investments in a fast-paced and ever-changing business environment. Workforces are often shared and geographically distributed.

Projects, risks and action items are often scattered across an enterprise. As a result, there is a lack of ownership of particular projects or associated risks and action items. In addition, key information and issues can and often does fall through the cracks or get lost. Meanwhile, lower priority information can be inappropriately escalated, thereby wasting valuable time. In addition, productivity can be lost when individuals at the enterprise try to manage by emails and attachments.

In today's business environment, there can be too much workload-related paper on the desk, and there are too many e-mails, to efficiently manage the workload. There is a need to focus on the items requiring attention. This frequently means re-processing the issues to determine which requires the most immediate attention. However, time constraints make it undesirable to re-prioritize issues such as periodic status reports and other information, whether presented electronically such as in e-mails or on paper.

These conditions are exacerbated by the fact that every major decision, performance disclosure, and financial report will be scrutinized as never before. Today's highly competitive business environment makes it imperative that management have the ability to efficiently stay abreast of organizational initiatives and issues. The result has been an unmet need for system and method to allow managers to efficiently monitor their active enterprises.

### BRIEF DESCRIPTION OF THE DRAWINGS

The above-mentioned and other advantages and features of the present invention will be better understood from the following detailed description of the invention with reference to the accompanying drawings, in which:

FIG. 1 is a block diagram illustrating a simplified and representative environment associated with a device arranged for managing workflow in accordance with one or more embodiments.

FIG. 2 is a block diagram of an exemplary ranking methodology, useful for discussing various concepts in connection with one or more embodiments.

FIG. 3 is a functional block diagram illustrating portions of an exemplary device for managing workflow, in accordance with one or more embodiments.

FIG. 4 is a flow chart illustrating an exemplary procedure for managing workflow information in accordance with various exemplary and alternative exemplary embodiments.

FIG. 5 is a flow chart illustrating an exemplary procedure for distributing, communicating, and/or reporting on topics in accordance with one or more embodiments.

FIG. 6 is an illustration of one example of a user interface for creating and assigning a topic, according to one or more embodiments.

FIG. 7 is an illustration of one example of a user interface for displaying a topic which is assigned to an owner, according to one or more embodiments.

FIG. 8 is an illustration of one example of a user interface for selecting a topic for a new communication, according to one or more embodiments.

FIG. 9 is an illustration of one example of a user interface for creating a communication corresponding to a topic, according to one or more embodiments.

FIG. 10 is an illustration of one example of a user interface for finalizing and sending at least one draft communication, according to one or more embodiments.

FIG. 11 is an illustration of one example of a user interface for a report on topics and communications, according to one or more embodiments.

FIG. 12-FIG. 14 are an illustration of one example of a user interface for accessing received communications, according to one or more embodiments.

FIG. 15 is a flow chart illustrating an exemplary procedure for creating and assigning a new topic, in accordance with various embodiments.

FIG. 16 is a flow chart illustrating an exemplary procedure for creating and sending a new communication, in accordance with various embodiments.

FIG. 17 is a flow chart illustrating an exemplary procedure for a user to access alerts and communications, in accordance with various embodiments.

### DETAILED DESCRIPTION

In overview, the present disclosure concerns electronic communications, often referred to as communications or messages, which may be transmitted and/or retrieved over a network with an operating capability to connect devices such as computers, such networks including for example a local area network, an intranet, the Internet, a cellular network, or the like. More particularly, various inventive concepts and principles are embodied in systems, devices, and methods therein for managing workflow information embodied in communications, where the workflow information can be distributed, communicated, or reported. It should be noted that the term device may be used interchangeably herein with computer, wireless communication unit, or the like. Examples of such devices include computers, personal digital assistants, cellular handsets, and equivalents thereof.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. Moreover, although the following detailed description includes many specific details, it is understood that the inclusion of such details is for the purpose of illustration and should not be understood to limit the invention. Also, throughout this discussion, similar elements are referred to by similar numbers in the various figures for ease of reference. In addition, features in one embodiment may be combined with features in other embodiments of the invention.

Much of the inventive functionality and many of the inventive principles when implemented, are best supported with or in software and/or integrated circuits (ICs), such as a digital signal processor and software therefore and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and/or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

As further discussed herein below, various inventive principles and combinations thereof are advantageously employed to provide a system of record for projects; to streamline communications conveying progress, plans, and issues; to provide access to communications and reports; and to provide alerts, for example by e-mail, of assignments and actions coming due.

No longer can an enterprise afford to have their projects, risks, issues and action items scattered across the enterprise. As such, the management of project investments has been re-thought in order to increase accountability, transparency, and visibility.

Further in accordance with exemplary embodiments, there is provided a system, device, and method for managing, distributing, reporting communications about workload-related information. Such communications can be provided in a manner which is succinct, measurable, actionable, relevant and time-based.

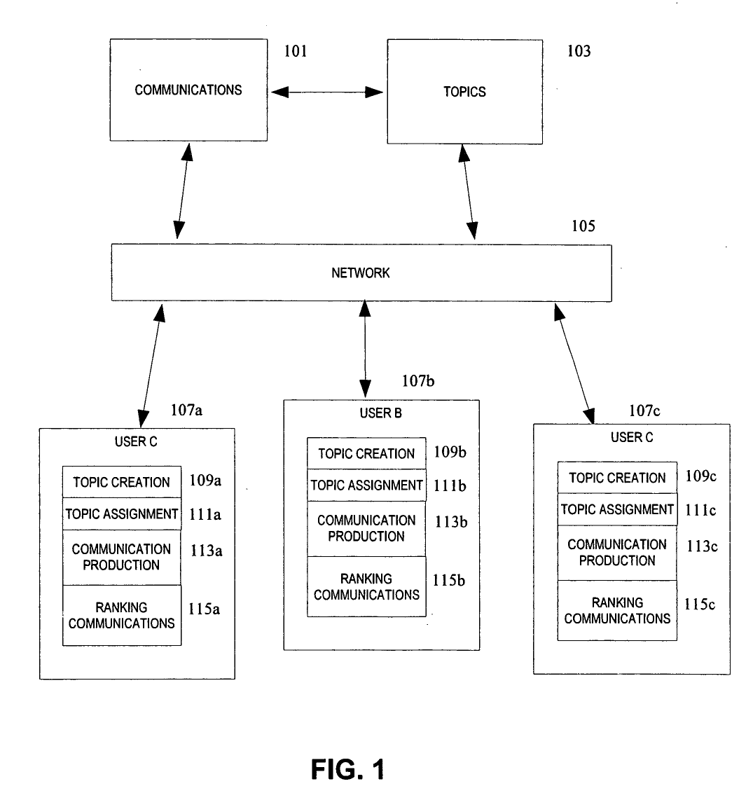

Referring now to FIG. 1, a block diagram illustrating a simplified and representative environment associated with a device and/or system arranged for managing workflow in accordance with one or more embodiments will be discussed and described. In overview, the representative environment illustrates a communications database 101, a topics database 103, and three devices 107a, 107b, 107c of users A, B and C.

The term “topic” is utilized herein to denote a project, a task, an action item, a risk, or the like. Generally, a topic relates to one or more aspects of a project that are to be managed. A topic is represented electronically, as further described in detail. Information about topics is electronically exchanged utilizing communications, or messages.

A project can be described as a temporary endeavor (typically having a definite start and a definite end) undertaken to create a product or service. It is understood that the end of a project is reached when the project's objectives have been achieved, or when it becomes clear that the project objectives will not or cannot be met, whereupon the project typically is terminated.

A task can be described as an entity of work required to complete a project. A task also typically has a definite start and end. An action item can be described as an entity of work required to complete a task. An action item typically has a definite start and end. A risk can be described as a potential future event that, should it occur, will have a negative effect on meeting the objectives of a project.

The devices 107a, 107b, 107c can communicate over a network 105, for example, a local area network, intranet, or the Internet. The communications database 101 and topics database 103 of the illustrated embodiment can be provided via the network 105. Further, one or more of the devices 107a, 107b, 107c can communicate remotely with the network 105 or can communicate with the network 105 via a cellular network (not illustrated).

One or more embodiments provide for creating and tasking (or assigning) topics to people across an enterprise. Also, one or more embodiments provide for reports on the topics and/or the communications. Communications and topics can be ranked, as further discussed herein, so that communications or topics of a higher overall ranking can be readily apparent.

Accordingly, the devices 107a, 107b, 107c in the illustrated embodiment can include a topic creation function 109a, 109b, 109c; a topic assignment function 111a, 111b, 111c; and communication production function 113a, 113b, 113c; and a ranking communications function 115a, 115b, 115c.

The topic creation function 109a, 109b, 109c can be utilized by a topic originator to create a particular topic (for example, project, risk, task or action item). A topic when created can be assigned various attributes, such as a description and/or a unique identifier. Topics can be stored in the topics database 103. The topic assignment function 111a, 111b, 111c can be used to assign the topic to a team of two or more users. Also, a topic can be assigned to an owner, who can be one of the team members. The topic can be assigned a priority, during the topic creation function 109a, 109b, 109c or during the topic assignment function 111a, 111b, 111c. Priority is intended to reflect relative priorities between topics. Priority values can be constrained to a predetermined value, such as by a drop-down menu. Users can be notified when topics are created and assigned to a team which they are on, or can access information indicating topics for their teams.

Also, the devices 107a, 107b, 107c can include a communication production function 113a, 113b, 113c. The communication production function can provide for one of the users sending a communication corresponding to a topic. A communication can be directed to any user on a team associated with a topic, and/or on an access list associated with a topic. Communications can be stored in the communications database 101.

Communications can be assigned an urgency and an importance, as well as inheriting the priority from the topic to which they correspond. Urgency is intended to reflect the relative timing for completion associated with a communication, for example, so that nearer due dates can have a higher urgency than later due dates. Importance is intended to reflect relative significance of a communication or information contained therein. Urgency and importance values can be constrained to pre-determined values, for example, by a drop-down menu.

Communications can be routed to designated recipients. Communications can be automatically routed to recipients, for example, to the team associated with the corresponding topic, and/or to the owner assigned to a topic. The automatic routing can be performed in response to creation of the communication. Accordingly, one or more embodiments provides for automatically routing the communication to the owner. Also, topics can be automatically routed to recipients when created. For example, when a topic is created and assigned to an owner, the topic can be sent to the owner. Accordingly, one or more embodiments provides for automatically routing, responsive to the creating, the topic to the owner.

Accordingly, one or more embodiments provide a computer system for managing workflow information, the workflow relating to a topic shared among a team of users. There is included a creation unit, configured to facilitate creating a plurality of topics, including assigning a priority to each of the topics. Also provided is a topic assignment unit, configured to facilitate tasking, responsive to an originator, a topic to an owner, and associating the topic with a team, the owner and the originator being members of the team. Also provided is a communication production unit, configured to facilitate producing a plurality of communications, including at least one communication, the at least one communication being initiated by a team member, and being assigned an urgency reflecting a deadline and an importance selected by the team member, and automatically associated with the priority assigned to the topic. The priority can be one of a plurality of pre-determined priorities, the urgency can be one of a plurality of pre-determined urgencies, and the importance can be one of a plurality of pre-determined importances. Also, an embodiment can include a ranking of the at least one communication relative to communications in the plurality of communications, which can be automatically calculated, in the computer, from a combination of the priority, the urgency, and the importance.

The communications database 101 and/or the topics database 103 can be located on local internal drives (not illustrated), local external drives, network attached storage (NAS), a storage area network (SAN), or the like, and can be distributed if desired. Because the topics and/or communications are stored in databases, metrics can be developed and performed, such as reports by team members, or for specific topics, or having specific rankings. Therefore, the topics and/or communications can be measurable.

In accordance with one or more embodiments, the topic can be a project, a task, an action item, or a risk.

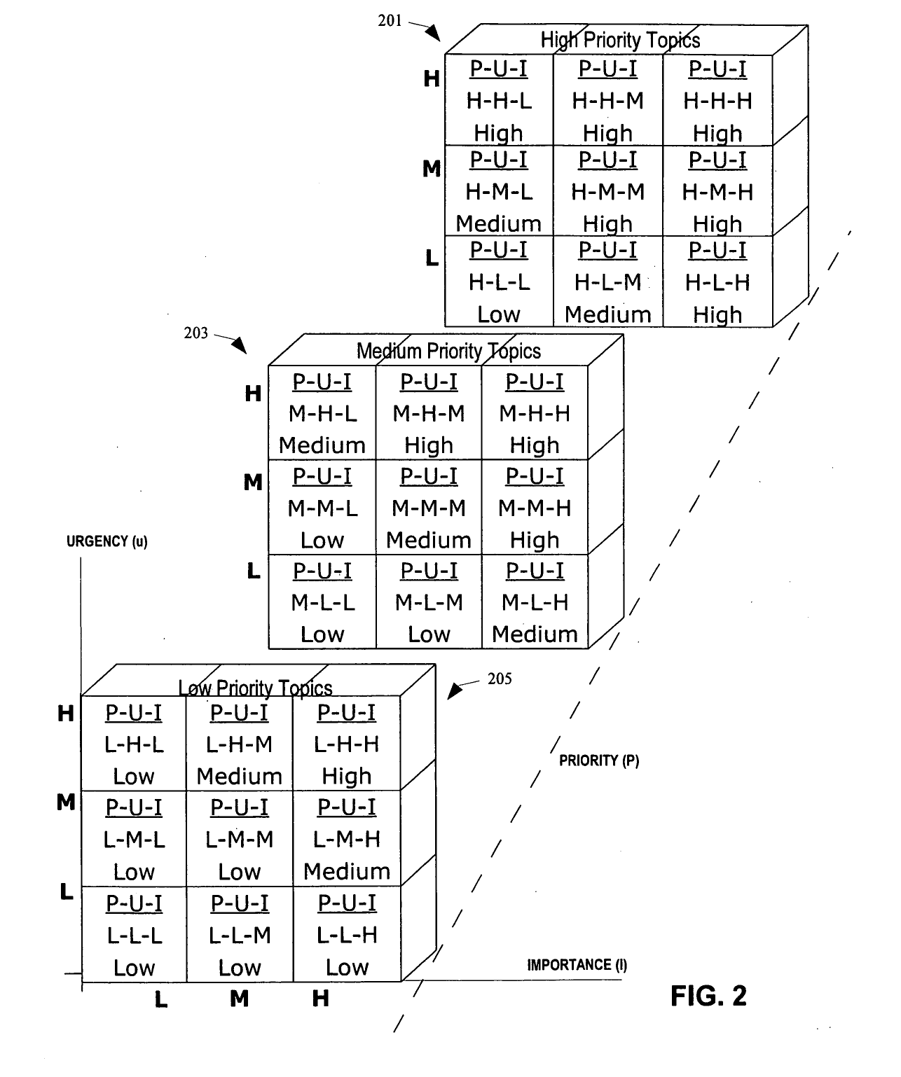

A communication can be ranked by the ranking communications function 1115a, utilizing a combination of the urgency, priority and importance assigned to the communication. (Ranking is discussed in more detail in connection with FIG. 2.) The relative ranking of multiple communications can be provided represented in reports or presentations of communications. A user can review communications that were sent by other users, or received by other users. Therefore, a presentation reflecting the ranking of communications can assist the user in discriminating amongst communications to determine those which merit prompt attention.

Accordingly, one or more embodiments further comprises a ranking unit, configured to facilitate the ranking of a portion of the communications in the plurality of communications responsive to a request, wherein the communications in the portion are associated with at least one team, at least one owner, at least one originator, or at least one topic specified in the request. The request can be for example, of a report. In accordance with one or more embodiments, the portion of communications can be limited to those associated with an owner, originator, team, and/or topic, wherein the limit is specified by the user or is automatic based on the user. Accordingly, one or more embodiments provides for reporting on the plurality of communications by the ranking, the report further being limited to communications responsive to at least one of owner, originator, team and topic.

Referring now to FIG. 2, a block diagram of an exemplary ranking methodology, useful for discussing various concepts in connection with one or more embodiments will be discussed and described. Communications can be ranked by their urgency and importance, and by the priority of the topic associated therewith.

In the example of FIG. 2, there are provided three values of urgency (“U”), priority (“P”), and importance (“I”): high (“H”), medium (“M”) and low (“L”). Also, there are provided three values of rank: “High”, “Medium” and “Low.” Accordingly, one or more embodiments provide that the priority, urgency, and importance each comprise high, medium and low values.

FIG. 2 represents all possible combinations of urgency, priority and importance, in addition to the ranking that is determined from each combination. The illustration is broken out to illustrate the combinations for lower priority topics 205, medium priority topics 203, and high priority topics 201.

One method of calculating a ranking includes assigning a numerical value to the priority value, importance value, and urgency value. For example high, medium and low values are utilized and can be assigned values of 3, 2 and 1, respectively. For a particular communication, additive values for priority, importance and urgency can yield a ranking of between 3 (lowest) to 9 (highest). Therefore:
P+U+I=R, (I)

where

P=priority value

I=importance value

U=urgency value

R=numerical ranking value

For example, consider a communication of high urgency and low importance, associated with to a low priority project (a P-U-I of L-H-L). The communication yields a numerical ranking value:
1+3+1=5 (2)

In the numerical ranking value system, low, medium and high are associated with, respectively, 3-5, 6, and 7-9. The ranking value can be represented as a numerical value, a color representing the ranking, a character representing the ranking, or any combination of the foregoing. Alternatively, the ranking can be calculated as the average of the priority value, importance value, and urgency value.

In the illustrated embodiment, the urgency, priority and importance are equally weighted in the calculation. One or more alternative embodiments can provide that urgency, priority and/or importance are provided with more or less weight in the calculation.

A communication can be assigned an urgency and importance, and can have a priority inherited from its corresponding topic. The ranking of each communication therefore can be determined automatically. Accordingly, one or more embodiments can provide for automatically ranking a portion of the communications by determining a combination of the priority, the urgency, and the importance associated with each communication in the portion, and associating the ranking with each communication in the portion. Further, one or more embodiments provide for ranking the communication relative to other communications in the plurality of communications, responsive to the priority, urgency and importance.

One or more embodiments provide that the ranking is determined when one or more communications stored, and the ranking information is stored with the communication. Alternative embodiments provide that the ranking is determined when one or more communications (or a summary thereof) are displayed. One or more embodiments provide that the priority of the topic corresponding to the communication is accessed when determining the ranking. Alternative embodiments provide that the priority of the corresponding topic is stored with the communication.

As a consequence of ranking communications, a user can discriminate between the rankings of communications. Thereby, the user can promptly discern which communications require attention.

The embodiment illustrated in FIG. 2 utilizes three values: low, medium and high. Accordingly, one or more embodiments provide that there are three pre-determined priorities, three pre-determined urgencies, and three pre-determined importances.

However, the principals can be applied to two or more values. Also, the embodiment illustrated herein utilizes three inputs: priority, urgency, and importance. The principals discussed herein can accommodate more than three inputs, if desired. Also, it will be appreciated that the value of “high”, “medium” and “low” can be replaced with other values, such as numbers, alphabetic symbols, character symbols, color representations, or the like; and that the values for the various inputs of priority, urgency and importance do not need to be identical.

When assigning an urgency or an importance to a communication, or assigning a priority to a topic, the user can be limited to pre-determined priorities, urgencies, and/or importances. For example, priorities, urgencies and/or importances can be presented for selection in a pull-down menu or similar interaction.

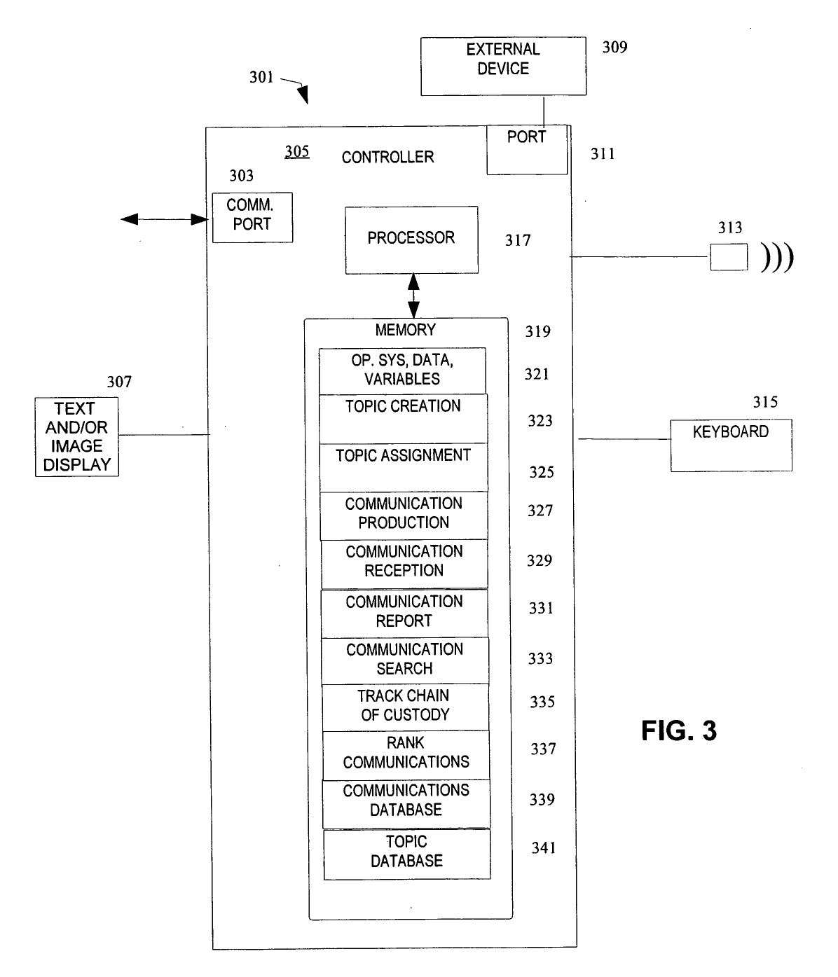

Referring now to FIG. 3, a functional block diagram illustrating portions of an exemplary device 301 for managing workflow, in accordance with one or more embodiments will be discussed and described. The device 301 may include one or more controllers 305. The controller 305 can be operably connected to a communication port 303 for sending and receiving transmissions on a network, a port 311 for communicating with an external device 309, a speaker 313, a text and/or image display 307, and/or a user input device such as a keyboard 315. The controller 305 can also include a processor 317 and a memory 319.

The processor 317 may comprise one or more microprocessors and/or one or more digital signal processors. The memory 319 may be coupled to the processor 317 and may comprise a read-only memory (ROM), a random-access memory (RAM), a programmable ROM (PROM), and/or an electrically erasable read-only memory (EEPROM). The memory 319 may include multiple memory locations for storing, among other things, an operating system, data and variables 321 for programs executed by the processor 317; computer programs for causing the processor to operate in connection with various functions such as topic creation 323, topic assignment 325, communication production 327, communication reception 329, communication report 331, communication search 333, track chain of custody 335, and rank communications 337; a database 339 of communications; a database 341 of topics; and a database (not illustrated) of other information used by the processor 317. The computer programs may be stored, for example, in ROM or PROM and may direct the processor 317 in controlling the operation of the device 301.

The processor 317 may be programmed for topic creation 323. A topic can be created, including assigning a priority and any desired descriptive topic information. Descriptive topic information can include, for example, a name or title for the topic, a topic type, a unique topic identifier, a description of the topic, a budget for the topic, an action plan, a start date, and/or an end date. The topic reflects a time base due to the inclusion of a start date and/or end date.

Text entry, for example, the name or title, description, and/or action plan, can be limited to a predetermined number of characters, so that the information concerning the topic is succinct. One or more embodiments can provide that the unique topic identifier is automatically generated. A topic type can be limited to pre-determined descriptions. Such pre-determined descriptions can be, for example, action or information.

Accordingly, one or more embodiments provide a creation unit, configured to facilitate creating a plurality of topics, including assigning a priority to each of the topics.

Further, one or more embodiments comprise creating the plurality of topics, including entering, responsive to a user, a description of the topic; assigning, responsive to the user, the priority to the topic; assigning, responsive to the user, an owner of the topic; assigning a team to the topic; and automatically assigning the user as the originator of the topic; wherein the owner and the user are members of the team.

The processor 317 can be programmed for topic assignment 325, where the topic is tasked to an owner, and where the team can be assigned. The owner and originator can be assigned as members of the team, and other members of the team can be selected. Alternatively, a team can be selected from pre-determined groups of users. One or more embodiments provide that the team can be automatically inherited from the owner or the originator of the topic.

Accordingly, one or more embodiments provide a topic assignment unit, configured to facilitate tasking, responsive to an originator, a topic to an owner, and associating the topic with a team, the owner and the originator being members of the team.

Also, the processor 317 can be programmed for communication production 327, wherein a communication is produced. A topic can be selected, to which the communication will relate. For example, a topic can be selected from topics of which the user is a team member. The communication can be created, including assigning an urgency, an importance, one or more recipients, and any desired descriptive communication information. Descriptive communication information can include, for example, message content, a type of message, and/or an end date. The communication can reflect a time base due to the inclusion of the end date. The priority of the topic can be assigned from the topic to which the communication relates. A communication type can be limited to pre-determined descriptions, for example, action or information.

Accordingly, one or more embodiments provides a communication production unit, configured to facilitate producing a plurality of communications, including at least one communication, responsive to the topic and automatically associated with the topic, the at least one communication being initiated by a team member, and being assigned an urgency reflecting a deadline and an importance selected by the team member, and automatically associated with the priority assigned to the topic. The priority is one of a plurality of pre-determined priorities, the urgency is one of a plurality of pre-determined urgencies, and the importance is one of a plurality of pre-determined importances.

Also, the processor 317 can be programmed for communication reception 329, where a user's device receives the communication or an indication that the communication is available. For example, when a communication is created, it can be stored in the communications data base (as discussed above). Further, the communication and/or a notification of the existence of the communication can be transmitted to the recipient(s) of the communication. Such communication and/or notification thereof can be received by a special purpose application, operating for example at the recipient's device or a host, or as a standard e-mail communication. One or more embodiments provide that the communication and/or notification is transmitted in response to creation of the communication. Alternatively, a periodic notification can be performed, including for example a periodic review of the communications database and notification to recipients of communications.

Accordingly, one or more embodiments provide for receiving a communication associated with the topic, responsive to creation of the communication. Also, one or more embodiments provides for a communication reception unit associated with a particular user, the particular user being a member of the team, configured to facilitate receiving the at least one communication associated with topics associated with the team.

Furthermore, the processor 317 can be programmed for communication report 331, including preparing a report of communications in response to a request initiated by a user and/or a periodic request initiated internally. One or more embodiments provide that the communications included in the report can be limited, for example, to a particular topic, to one or more particular teams, to one or more particular owners, to one or more particular originators, to one or more particular rankings, to a particular type of communication, and/or by other fields appearing within communications. The information can be presented in various ways. For example, it may be convenient to present information regarding the communication together with information regarding the topic to which it relates.

Accordingly, one or more embodiments provide for a report unit configured to facilitate preparing a report of communications responsive to a request including the ranking of a portion of the communications in the plurality of communications, and providing the report including information representative of the communications and topics in the portion and the ranking of the communications, wherein the communications in the portion are associated with at least one team, at least one owner, at least one originator, or at least one topic specified in the request.

Also, one or more embodiments provide for a report unit, configured to facilitate providing a report, responsive to a user, of communications for which the user is a team member of the associated topic, including an indication for each communication in the portion of: the corresponding topic, the topic description associated with the corresponding topic, the communication description associated with the communication, the action indication, and if for action, the end date associated with the action.

One or more embodiments further provides for reporting such as topic aging reports, displaying all open topics; and topic history reports, displaying all changes associated with a particular topic.

The processor 317 can be programmed for the communication search function 333, wherein the processor can search through the communications database and/or through communications received by or routed to a user performing the search. The search can be performed to locate communications responsive to search criteria. Search criteria can include one or more fields represented in the communication. Also, searches can be performed on keywords, which optionally can be stored in correspondence to the communications. Search criteria can be entered, for example by manual or semi-automated interaction with the user; by previous selection of default search criteria; and/or by system default, for example, search for communications where the user is a recipient, owner, originator or team member. In particular, one or more embodiments provide that searching can be performed by topic, whereby the user can identify communications related to a particular topic. Also, one or more embodiments can provide that searching can be performed by priority, urgency, and/or importance, whereby the user can identify communications which are, for example, particularly urgent (without regard to priority or importance). Further, one or more embodiments can provide that searching can be performed by ranking, whereby the user can identify communications which have a specific rank. Where the search is performed including priority, urgency, and importance (or a combination thereof, including ranking), the search be further limited by further specifying keyword, owner, and/or originator.

Accordingly, one or more embodiments provide for searching the plurality of communications by topic, priority, urgency, importance, or ranking. Also, one or more embodiments provides for searching the plurality of communications by priority, urgency, importance, and at least one of keyword, owner, and originator.

The processor 317 can be programmed for tracking chains of custody 335 of communications. Generally, each communication is independent. However, one or more embodiments can provide that communications can be forwarded and/or replied to. Accordingly, a particular communication can have a history of recipients; editing; forwarding or replying; and/or time stamps for actions such as editing, forwarding, and/or replying; and/or other information which is desired to be tracked. The history and/or time stamps for communications can be logged to provide a chain of custody. Also, chains of custody can be provided for review, for example, by selecting a chain of custody report for one or more communications. Thereby, a user can ascertain a communication's history, which increases accountability within an organization.

Accordingly, one or more embodiments provide that at least one communication includes a chain of custody indicative of originators and intervening recipients associated with the at least one communication.

The processor 317 can be programmed for ranking of communications 337. A communication can be ranked utilizing a combination of the urgency, priority and importance assigned to the communication. Communications can be ranked at any appropriate opportunity, for example when they are created, when they are stored, when urgency or importance associated with the communication is changed, when priority associated with the corresponding topic is changed, when they are reported or retrieved, or the like. Typically, ranking can be done on the portion of communications requested, reported, retrieved, stored, created, or affected by a change. Ranking was previously discussed in detail, for example in connection with FIG. 2 in which the illustrated ranking was based on an equally-weighted combination of the priority, urgency, and importance associated with each communication.

Accordingly, one or more embodiments provides a ranking unit, configured to facilitate ranking a portion of the communications by automatically calculating a value for each communication in the portion from an equally-weighted combination of the priority, the urgency, and the importance associated with each communication, the value indicating a rank of each communication in comparison to other communications; and associating the rank with each communication in the portion.

Optionally, other components may be incorporated in the device 301 to produce other actions. For example, a user can interface with the device 301, via a known user interface such as OUTLOOK, WINDOWS, and/or other commercially available interfaces. Further, the device 301 can send and receive transmissions via known networking applications operating with the communications port 303 connected to a network, for example, a local area network, intranet, or the Internet and support software.

It should be understood that various embodiments are described herein in connection with logical groupings of functions. One or more embodiments may omit one or more of these logical groupings. Likewise, in one or more embodiments, functions may be grouped differently, combined, or augmented. For example, in one or more embodiments, users may not be permitted to create or assign topics, and accordingly the device 301 can omit the topic creation 323 or topic assignment 325 functions. Also, in one or more embodiments, the communication reporting 331, communication searching 333, communication ranking 337, and chain of custody 335 functions may be performed predominantly or entirely on a remote computer (not illustrated); and therefore such functions can be reduced or omitted from the processor 317 and distributed to the remote computer. Similarly, the present description may describe various databases or collections of data and information. One or more embodiments can provide that databases or collections of data and information can be distributed, combined, or augmented, or provided locally (as illustrated) and/or remotely (not illustrated).

The user may invoke functions accessible through the keyboard 315. As alternatives to the keyboard 315, or in addition to the keyboard 315, one or more other various known input devices can be provided, such as a keypad, a computer mouse, a touchpad, a touch screen, a trackball, and/or a pointing device.

The device 301 can include or be connected to the text and/or image display 307, upon which information may be displayed. The display is optional for one or more embodiments. The display 307 may present information to the user by way of a conventional liquid crystal display (LCD) or other visual display, and/or by way of a conventional audible device (such as the speaker 313) for playing out audible information.

The device 301 can include one or more of the following, not illustrated: a floppy disk drive, a hard disk drive (not shown), and a CD ROM or digital video/versatile disk, at internal or external hard drives. The number and type of drives can vary, as is typical with different configurations, and may be omitted. Instructions for operating the processor 317 can be provided electronically, for example, from the drive, via the communication port 303, or via the memory 319. Accordingly, one or more embodiments provide for a computer-readable medium comprising instructions for execution by a computer, where the instructions include a computer-implemented method for managing communications related to status of a plurality of topics.

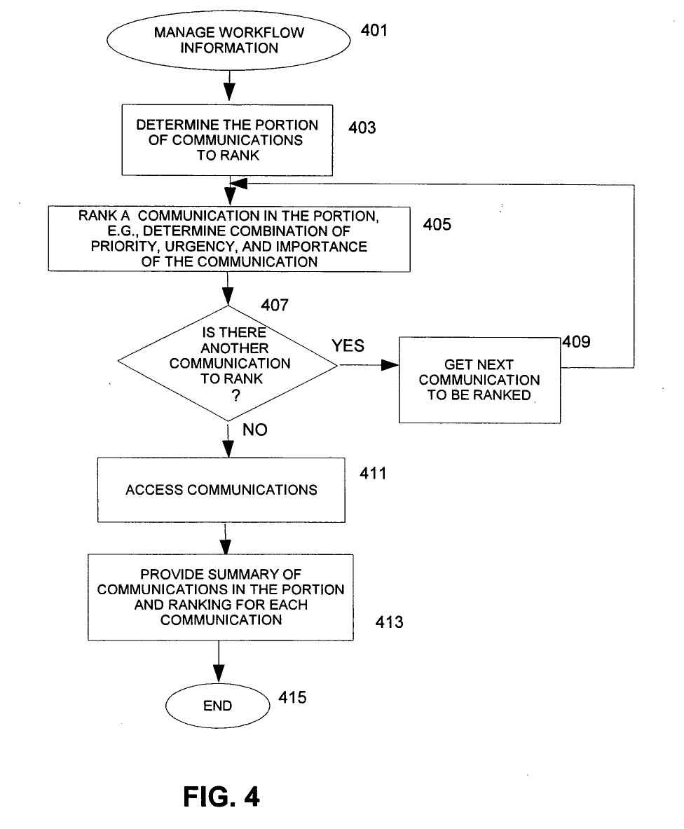

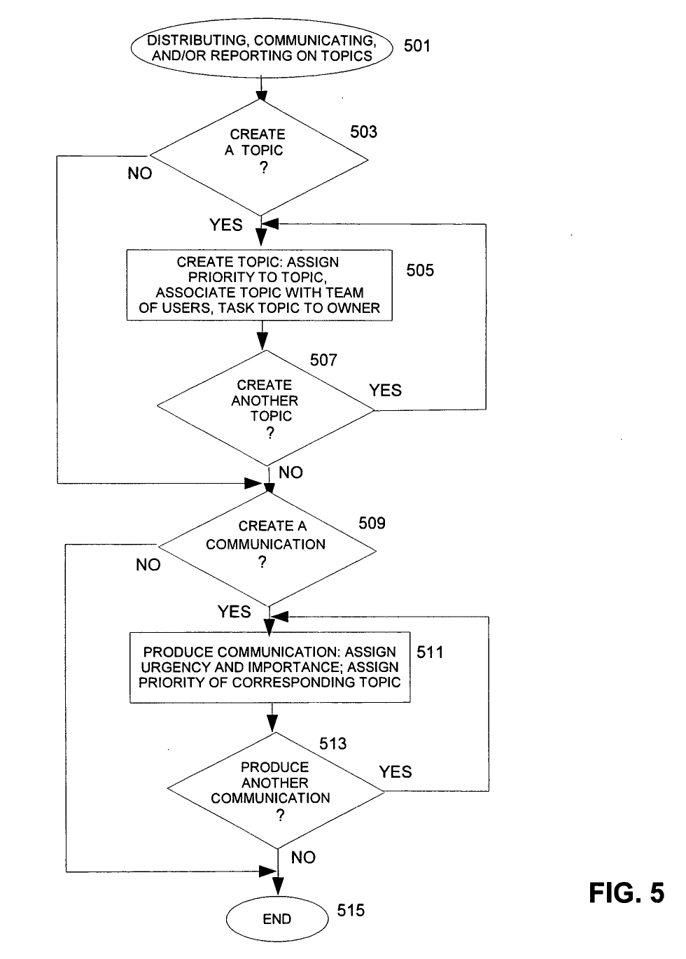

FIG. 4 and FIG. 5 are flow charts, illustrating exemplary procedures for various aspects of one or more embodiments. FIG. 4 illustrates managing workflow information, whereas FIG. 5 illustrates distributing, communication, and/or reporting on topics shared among users.

Referring now to FIG. 4, a flow chart illustrating an exemplary procedure for managing 401 workflow information in accordance with various exemplary and alternative exemplary embodiments will be discussed and described. The procedure can advantageously be implemented on, for example, a processor of a controller, described in connection with FIG. 3, or other apparatus appropriately arranged, or a network of such apparatuses.

In overview, a procedure for managing 401 workflow information can include determining 403 the portion of communications to be ranked. The procedure 401 then can rank 405 the communication in the portion, checks 407 whether there is another communication to rank, and if so gets 409 the next communication to be ranked and loops back to rank 405 the communication. Having ranked the communications in the portion, the procedure then can access 411 the communications and can provide 413 a summary of the communications in the portion and a ranking for each communication. Processing can then end 415. Each of the foregoing is described in more detail below.

The procedure can include determining 403 the portion of communications to be ranked. For example, all communications may be ranked, or communications which were just created and are to be stored can be ranked, or communications which were retrieved (such as for a report) can be ranked. In any event, one or more communications have been selected via various means for further display or other processing, including searching, reporting, notifying, and the like described herein. It is that portion of the communications which can be ranked.

Typically, the procedure will loop through the communications in the portion and rank each independently. Consequently, the procedure can get the first communication in the portion, and can then rank 405 that communication. Ranking has been previously described, and can include for example determining the combination of priority, urgency, and importance of the communication. If necessary, the priority can be determined from the associated topic by retrieving the priority of the topic.

The procedure can check 407 whether there is another communication to be ranked in the portion of communications. If so, the procedure can get 409 the next communication to be ranked. The procedure can loop back to rank 405 the next communication, as just described. The processing continues for all of the communications in the portion.

Having ranked the communications in the portion, the procedure can then access 411 the communications. For example, the communications (or portion thereof) can be retrieved from the communications database, or from a locally stored copy of the portion of the communications.

The procedure can provide 413 a summary of the communications in the portion and a ranking for each communication. Example illustrations of various reports are provided below. However, a variety of reports can be provided which display at least a portion of the information for each communication, including the ranking. Processing can then end 415.

Accordingly, one or more embodiments can provide for accessing a plurality of communications, each communication having an urgency reflecting a deadline, an importance, and a priority, the priority being inherited from a corresponding topic of a plurality of topics, wherein the priority is one of a plurality of pre-determined priorities, the urgency is one of a plurality of pre-determined urgencies, and the importance is one of a plurality of pre-determined importances, each communication being associated with the corresponding topic, and each communication being associated with a communication originator; each topic being associated with an owner, a team, and a topic originator and having a priority assigned thereto.

Referring now to FIG. 5, a flow chart illustrating an exemplary procedure 501 for distributing, communicating, and/or reporting topics in accordance with one or more embodiments will be discussed and described. The procedure 501 can advantageously be implemented on, for example, a processor of a controller, described in connection with FIG. 3 or other apparatus appropriately arranged, or a network of such apparatuses.

In overview, the procedure 501 can include creating topics 503, 505, 507, and creating communications 509, 511, 513. Creating topics 503, 505, 507 can include checking 503 whether a topic is to be created, creating 505 the topic, checking 507 whether another topic is to be created, and if so looping to create 505 the next topic. Creating communications 509, 511, 513 can include checking 509 whether a communication is to be created, producing 511 the communication, checking 513 whether another communication is to be produced, and if so looping to create 511 another communication. Processing can then end 515. Each of the foregoing is described in more detail below.

The loop for creating topics can include checking 503 whether a topic is to be created. For example, the procedure can interact with the user to determine whether it is desired to create a topic. Creating 505 the topic can include assigning a priority to the topic, associating the topic with a team of users, and tasking the topic to the owner of the topic. Tasking the topic can include assigning one of the team members as the owner and notifying the team member of the topic. Also, one or more embodiments can provide that the topic can have an end date associated with it. Additional processing has been previously described, including for example storing the topic in the topic database. The procedure can check 507 whether another topic is to be created, and if so can loop to create 505 the next topic. For example, the procedure can interact with the user to determine whether it is desired to create another topic.

The loop for creating communications 509, 511, 513 can include checking 509 whether a communication is to be created. The procedure can interact with the user, for example, to determine if a communication is to be created. Producing 511 the communication can include assigning an urgency and importance to the communication, associating the communication with a topic, and assigning to the communication the priority of the associated topic. Also, one or more embodiments can provide that the communication can have an end date associated with it. Other optional information can be provided, such as text content and recipient(s), and has previously been described herein. Optionally, the urgency can be responsive to the end date of the communication, wherein the urgency escalates one or more levels as the end date approaches or arrives. The procedure can check 513 whether another communication is to be produced, and if so can loop to create 511 another communication. For example, the procedure can interact with the user to determine whether it is desired to create another communication. Processing can then end 515.

Accordingly, one or more embodiments provide for creating a plurality of topics including a topic, including assigning a priority to the topic, associating the topic with a team of users, and tasking the topic to an owner, the owner being one of the users of the team; and producing a plurality of communications responsive to the topic, each of the communications being initiated responsive to a user of the team and being assigned, at least one of manually and semi-automatically responsive to the user, an urgency representative of a time for completion and an importance, the communication being automatically assigned the priority assigned to the topic.

Moreover, accordingly, one or more embodiments include associating an end date with at least one of the at least one topic and the at least one communication, wherein the urgency is further responsive to the end date.

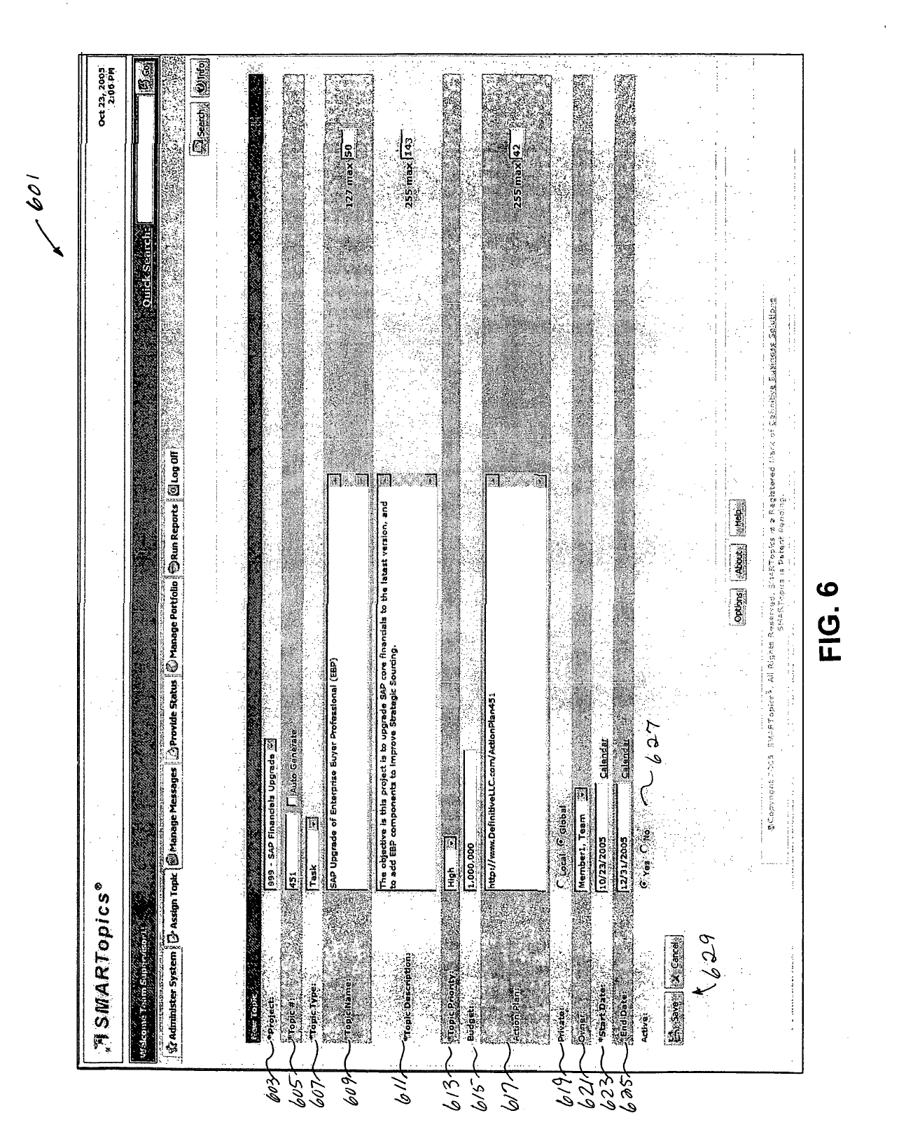

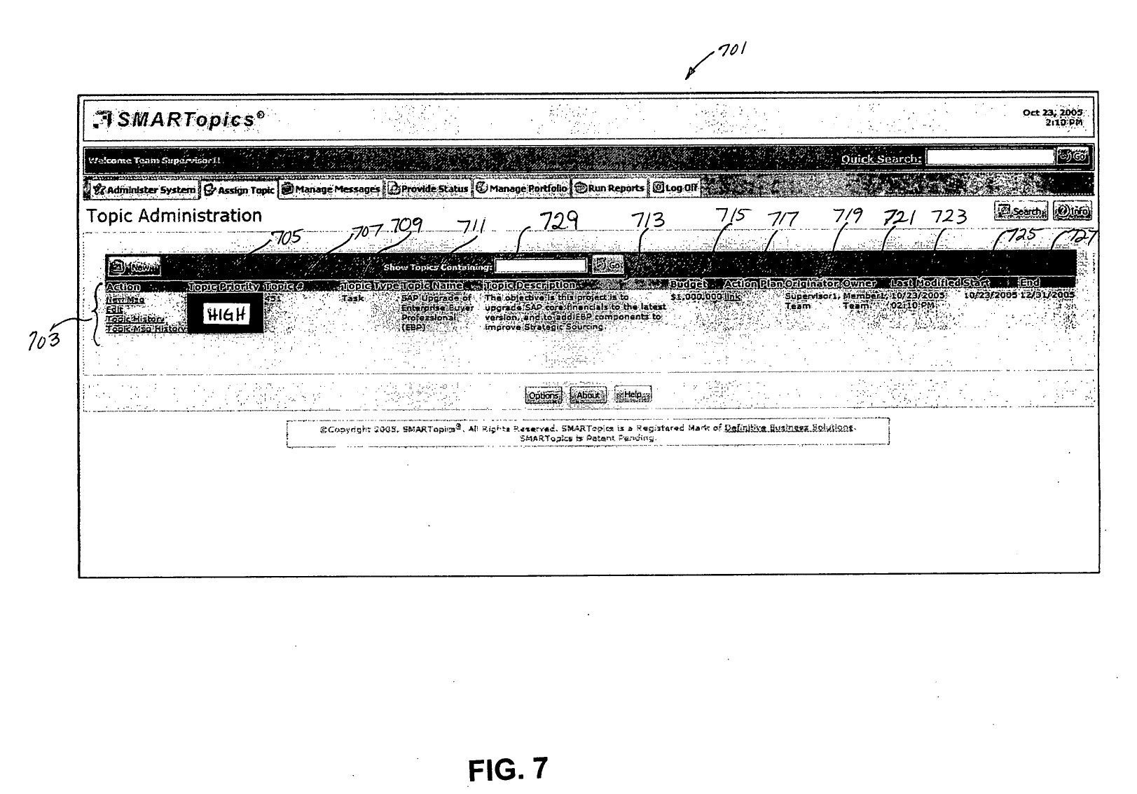

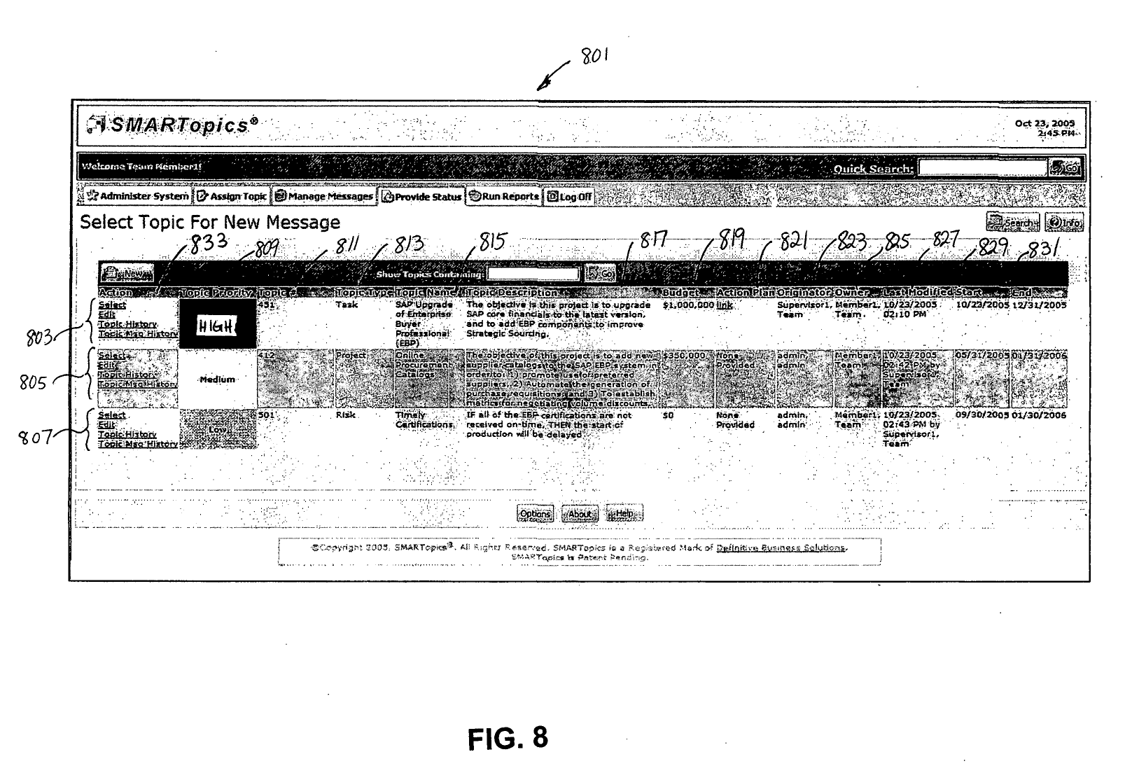

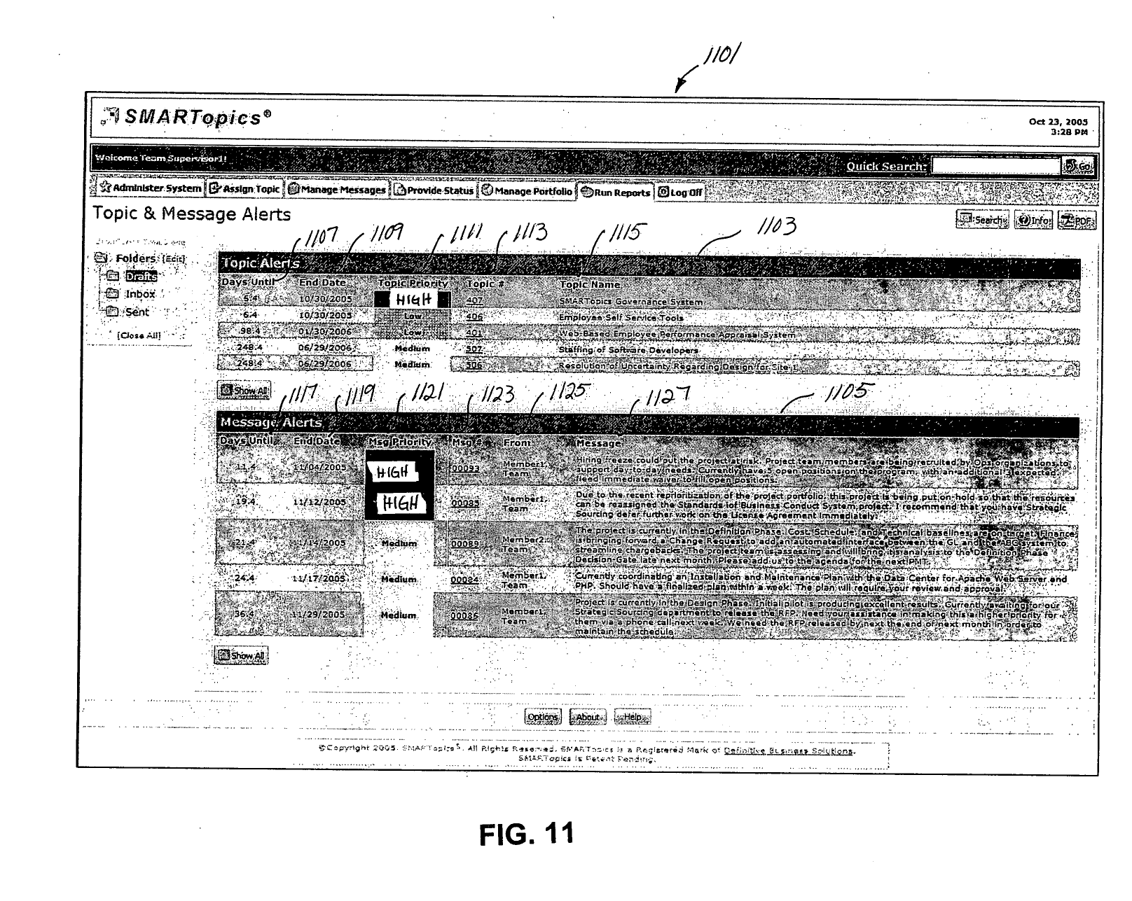

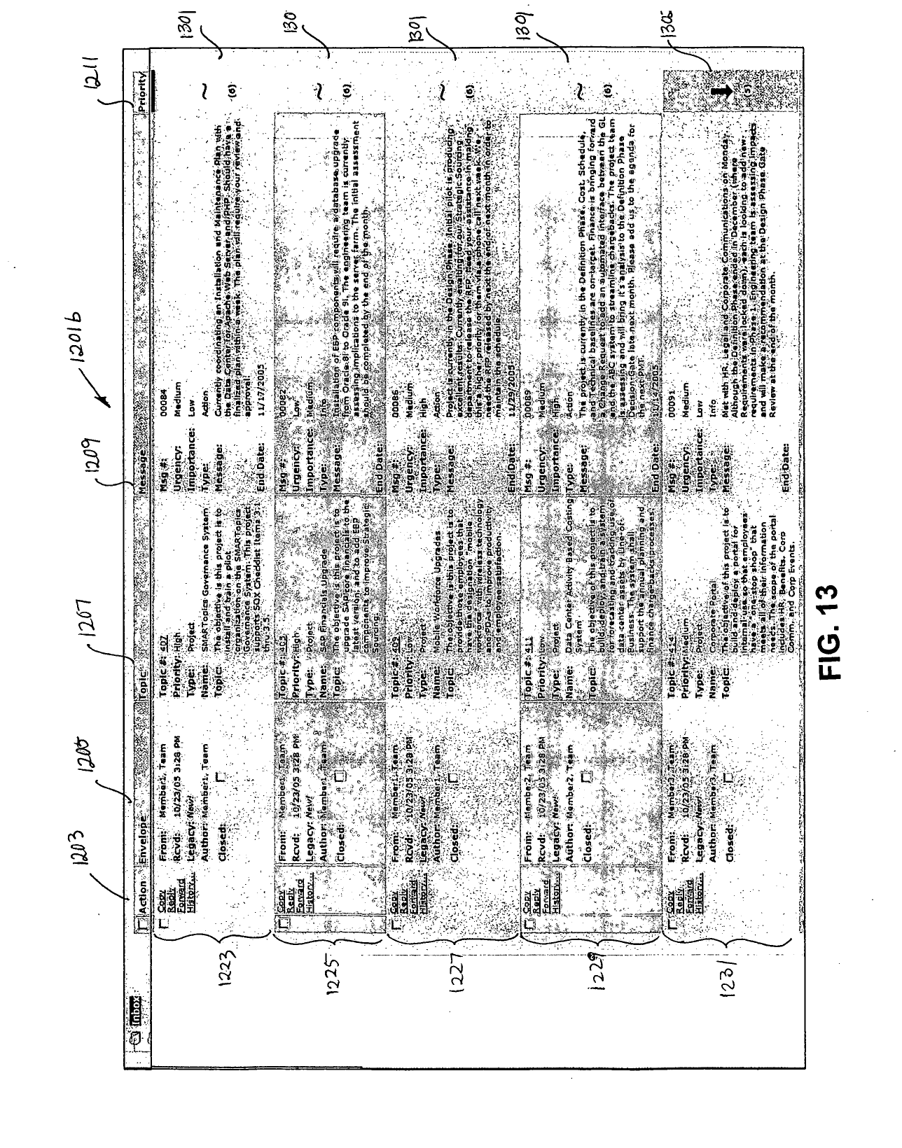

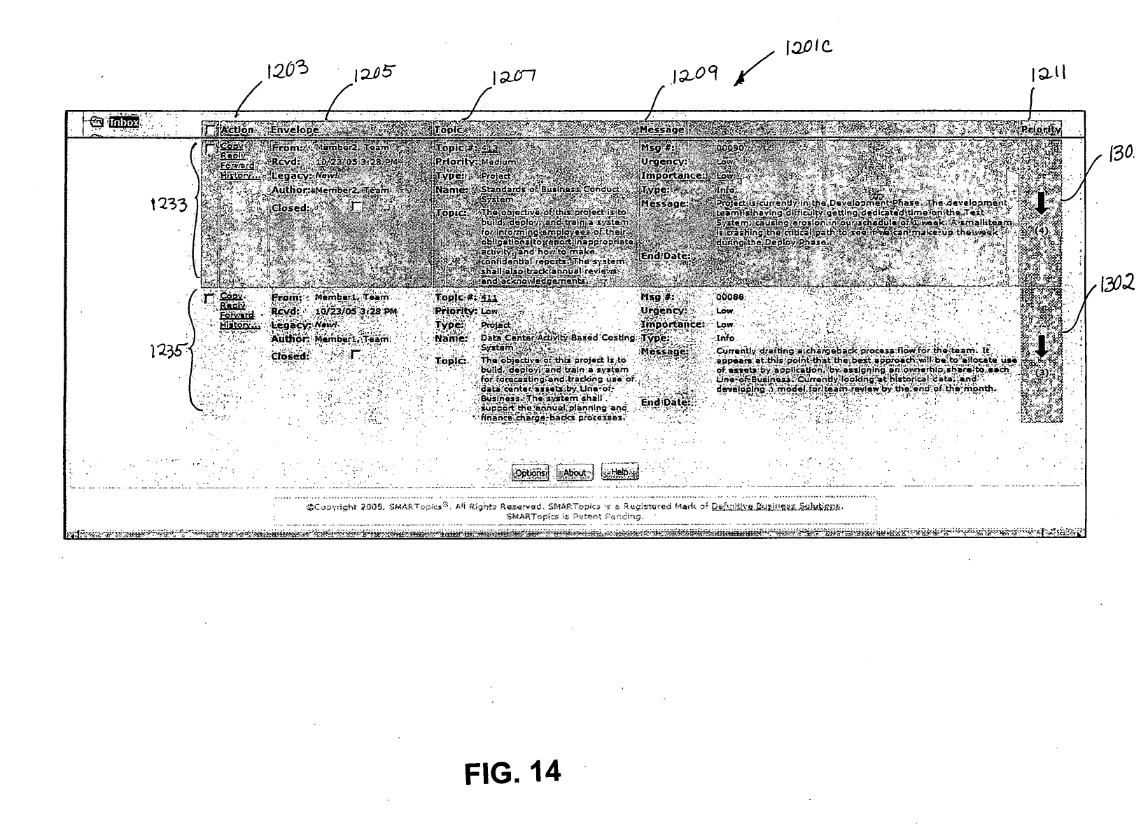

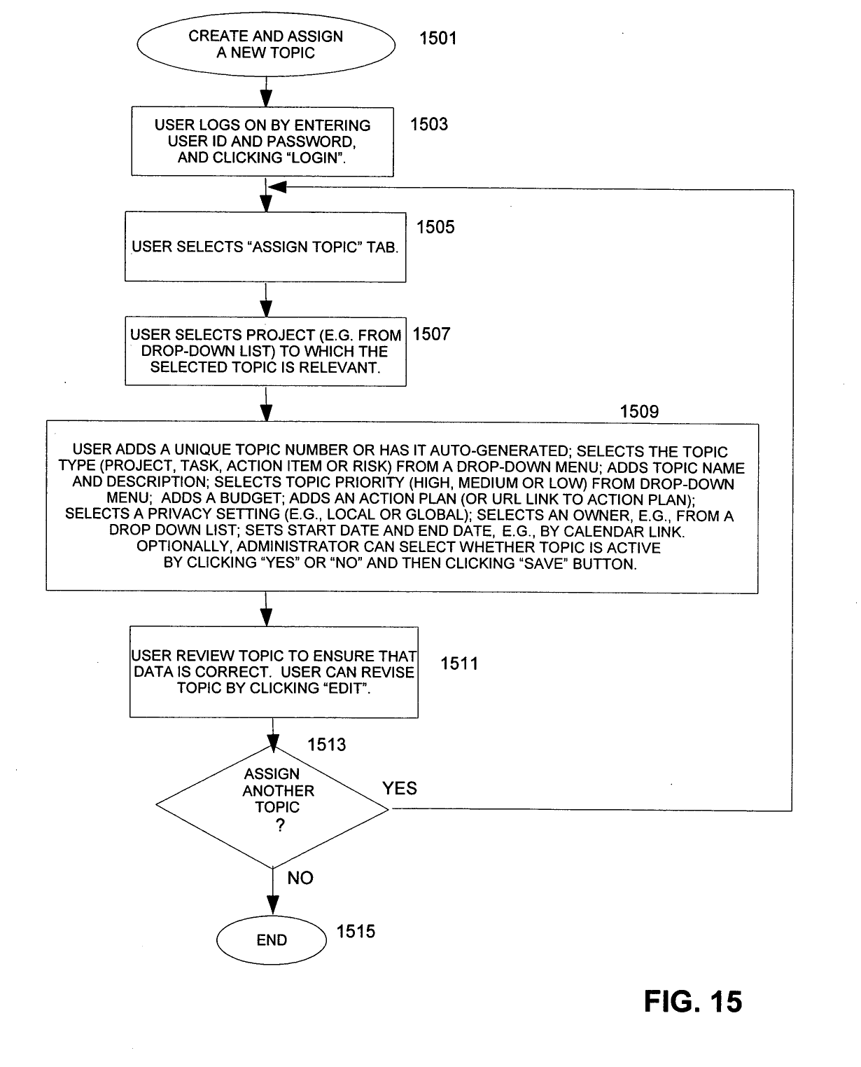

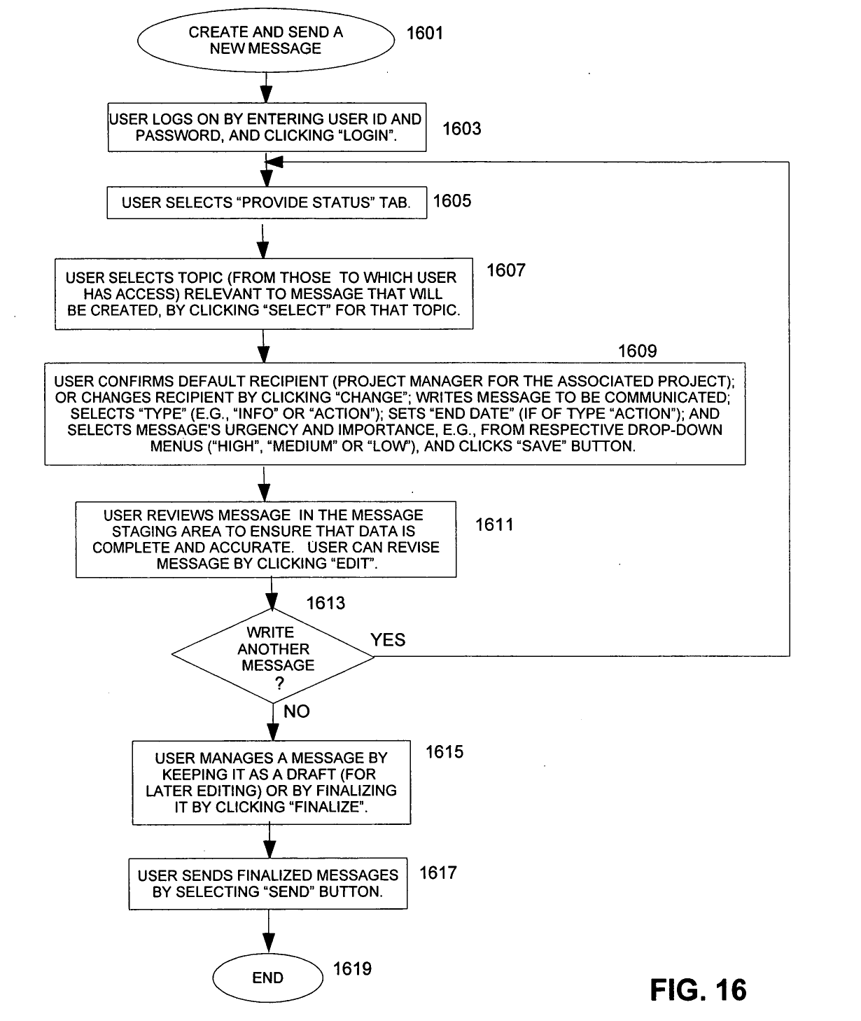

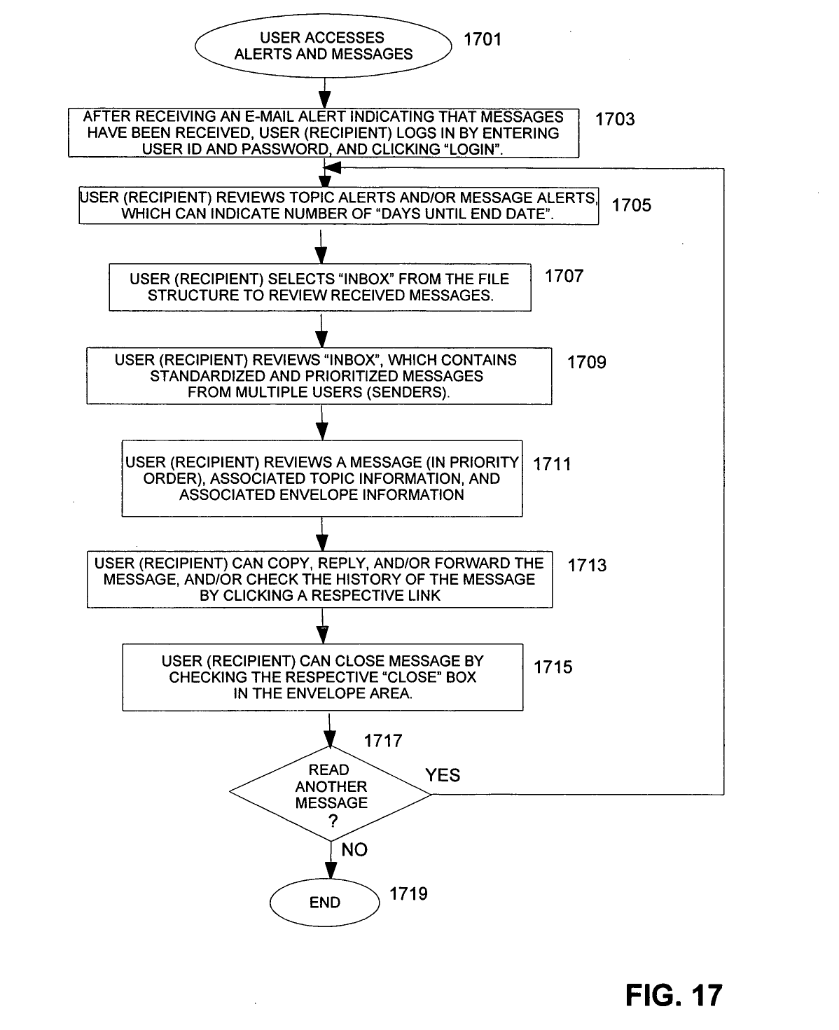

FIG. 6-FIG. 14 are illustrative user interfaces which depict how one or more embodiments can implement possible interactions with a user for some of the various functions which have been described. Furthermore, FIG. 15, FIG. 16 and FIG. 17 provide flow charts associated with the illustrative user interfaces of FIG. 6-FIG. 14. FIG. 6-FIG. 7 provide example illustrations of creating and assigning topics; FIG. 15 illustrates a corresponding exemplary flow chart. FIG. 8-FIG. 10 provide example illustrations of creating and sending communications; FIG. 16 illustrates a corresponding exemplary flow chart. FIG. 11-FIG. 14 provide example illustrations of accessing received topics and communications; FIG. 17 illustrates a corresponding exemplary flow chart. The user interfaces of FIG. 6-FIG. 14 are discussed first below, followed by a discussion of the flow charts of FIG. 15-FIG. 17.

More particularly, FIG. 6 and FIG. 7 together provide an illustration of a user creating and assigning a new topic: FIG. 6 depicts an exemplary creation and assignment of a new topic, whereas FIG. 7 depicts an exemplary report of topics.

Referring now to FIG. 6, an illustration of one example of a user interface 601 for creating and assigning a topic, according to one or more embodiments will be discussed and described. The user interface 601 illustrated here and subsequently can utilize drop-down menus to limit the user's selection to pre-defined options. The illustrated user interface 601 includes a project indicator 603, topic indicator 605, topic type 607, topic name 609, topic description 611, and topic priority 613.

The project indicator 603 can indicate a particular project with which the topic is associated, where the project is a topic (having a topic type of project) that was previously indicated. For a topic having a topic type of project, the project indicator either points to itself or is empty.

The topic indicator 605 can provide a unique identifier associated with the topic; it can be user-selected or automatically generated.

The topic type 607 can indicate the type of the topic, such as a project, task, risk or action item. The topic name 609 can contain content determined by the user, such as text. The topic description 611 can include a user-provided description of the topic. Optionally, text of the topic name 609 and/or topic description 611 can be limited to a maximum number of characters. The topic priority 613 can be selected by the user from pre-determined priorities, such as high, medium or low.

The illustrated user interface 601 also includes a budget indicator 615, action plan description 617, private indicator 619, owner indicator 621, start date 623, end date 625, and active indicator 627. The budget indicator 615 can include user-provided content optionally indicating a budget amount. The action plan description 617 can include a user-provided description of the action plan. Optionally, the text of the action plan 617 can be limited to a maximum number of characters. The private indicator 619 can indicate permissions for accessing the topic, such as global or local. The owner indicator 621 can indicate the user assigned as the owner of the topic; the illustrated user interface limits potential owners to known team members by utilizing a drop-down menu. The start date 623 and end date 625 indicate calendar days associated with the project, as selected by the user. The active indicator 627 is intended to indicate whether the topic is active or not, that is, whether the topic is a draft or has been added to the topic database and is in use.

In addition, the user interface 601 provides a save/cancel button, so that the topic can be saved for further editing or canceled if desired.

Referring now to FIG. 7, an illustration of one example of a user interface 701 for displaying a topic which is assigned to an owner, according to one or more embodiments will be discussed and described. The user interface 701 can display information associated with a topic, such as the information collected and discussed in connection with FIG. 6, as well as other information that is associated with the topic.

The illustrated user interface 701 includes an indicator of information provided by the user in the creation of the topic, such as topic priority 705, topic identifier 707, topic type 709, topic name 711, topic description 713, topic budget 715, topic action plan 717, topic owner 721, start date 725, and end date 727. Also, the illustrated user interface 701 indicates other information associated with the topic, such as the originator 719 of the topic, and the date the topic was last modified 723. Conveniently, the information can be displayed in a row so that multiple topics can be provided on a single screen.

In addition, the illustrated user interface 701 can provide actions 703 which can be performed on the topic. In this example, the actions 703 include creating a new message, editing the topic, displaying topic history, and displaying topic message history. A new message created from this topic will be associated with this particular topic. A topic history provides a review of a log of actions taken with respect to the particular topic. A topic message history provides a review of a log of messages associated with the particular topic, and optionally of actions for the associated messages.

In the illustrated user interface 701, a search criteria 729 can be utilized to search for topics containing specified terms or keywords. Similarly, other user interfaces can utilize search criteria to search for topics and/or communications containing specified terms, keywords, or contents of other searchable fields.

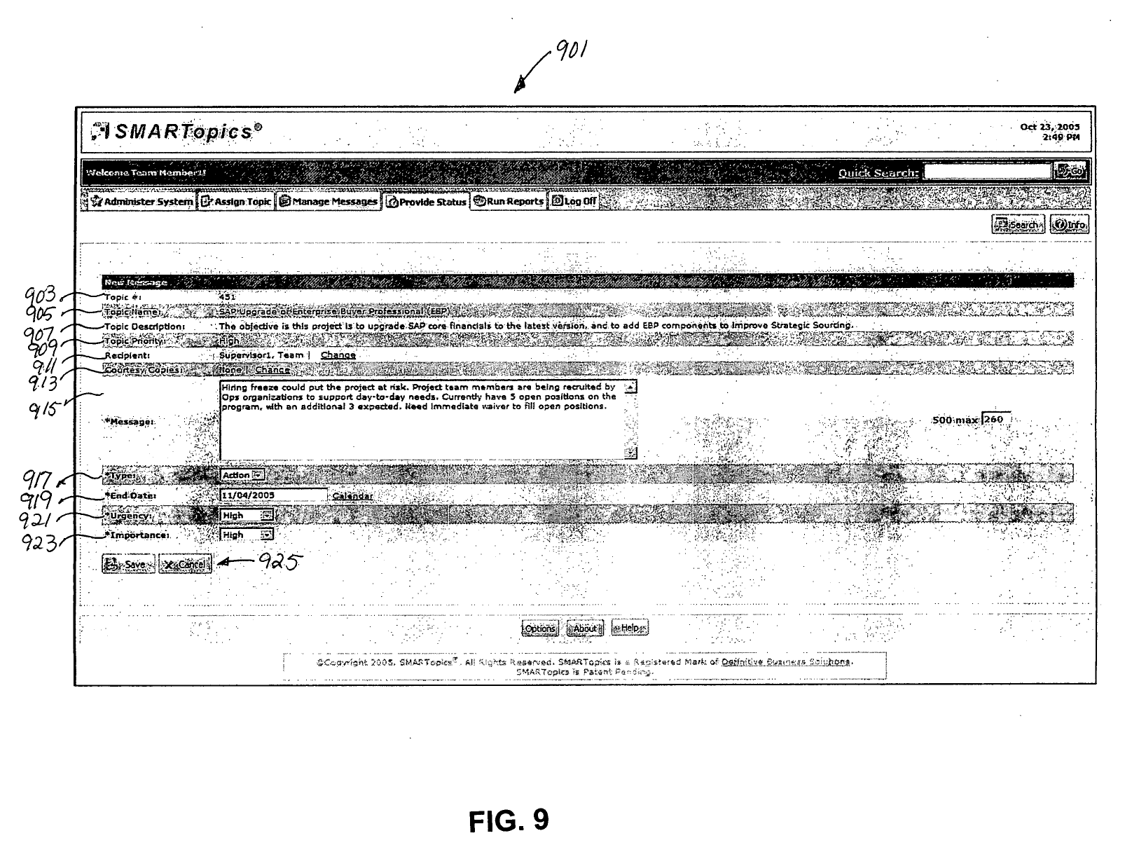

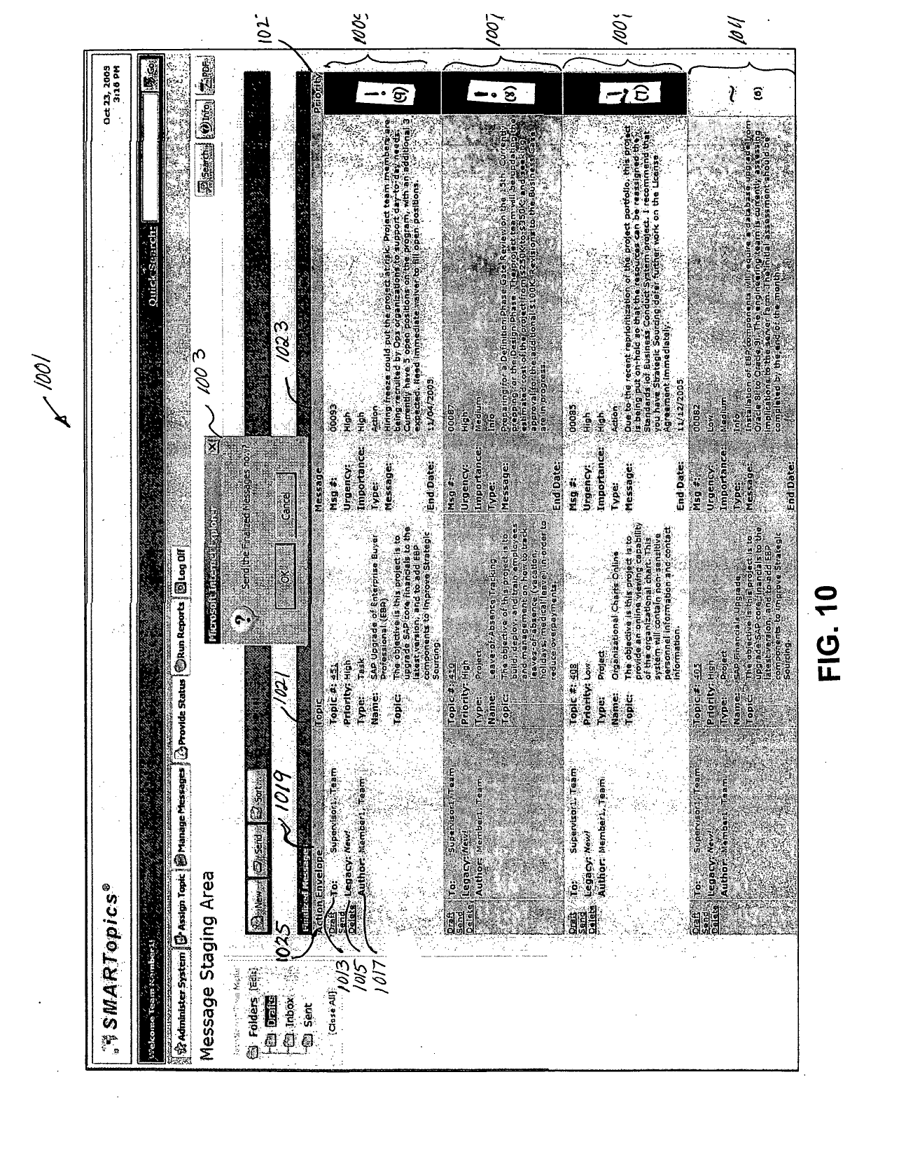

FIG. 8, FIG. 9 and FIG. 10 together provide an illustration of a user creating and sending communications, in accordance with various embodiments. In FIG. 8, the user selects a topic from several available topics; in FIG. 9, the user creates a communication corresponding to the selected topic; and in FIG. 10, the user sends the communication. A corresponding flow chart is illustrated in FIG. 16.

Referring now to FIG. 8, an illustration of one example of a user interface 801 for selecting a topic for a new communication, according to one or more embodiments will be discussed and described. The illustrated user interface 801 provides a display of information related to available topics including a first topic 803, a second topic 805, and a third topic 807 representative of any number of topics that can be displayed. Available topics can include, for example, topics retrieved from a search, or by default.

Further, the illustrated user interface 801 includes an indicator of information associated with the topic, such as topic priority 809, topic identifier 811, topic type 813, topic name 815, topic description 817, topic budget 819, topic action plan 821, topic originator 823, topic owner 825, last modified 827, start date 829, and end date 831. In the illustrated embodiment, all of the available information associated with the topics is displayed. Alternative embodiments can provide condensed versions or can omit some of the information.

The illustrated user interface 801 can provide actions 833 which can be performed on the topic. In this example, the actions 833 include creating a new message, editing the topic, displaying the topic history, and displaying the topic message history. In this example, the user action is “select,” to select the first topic 803, in order to create a communication corresponding to the first topic 803. (In the illustrated embodiment, a communication is referred to as a “message”.) Upon selecting the first topic 803, the next user interface (illustrated in FIG. 9) is displayed in order to create the communication.

Referring now to FIG. 9, an illustration of one example of a user interface 901 for creating a communication corresponding to a topic according to one or more embodiments will be discussed and described. The illustrated user interface 901 displays information regarding the topic corresponding to the message: the topic indicator 903, the topic name 905, the topic description 907, and the topic priority 909.

The user interface 901 can interact with the user to determine a communication recipient 911, one or more recipients of courtesy copies 913, text content of the message 915, communication type 917, end date 919, urgency 921, and importance 923. The illustrated user interface 901 can limit the communication recipient 911 to the team associated with the topic, conveniently by utilizing a drop down menu of team members. The illustrated user interface can also interact with the user to determine one or more recipients of courtesy copies 913 of the communication, for example, other users (not necessarily team members). Where the embodiment does not automatically provide copies of communications to team members, courtesy copies can also be provided to selected team members.

The user interface 901 can also interact with the user to determine the text content of the message 915, which can optionally be limited to a maximum character length. Also, the user interface 901 can interact with the user to determine communication type 917 (such as action or information), and where the communication type is “action”, to determine end date 919. The user interface 901 can interact with the user to assign an urgency 921 and importance 923 to the communication.

Accordingly, one or more embodiments provide that each topic is associated with a topic description; and that each communication is associated with a communication description, the communication description for the communication having less than a pre-determined limited character length. Also, one or more embodiments can provide that each communication includes an action indication whether the communication is for information or for action, and if for action, indicates an end date associated with the action. Further, one or more embodiments can provide that the instructions for providing the summary of the communications in the portion further include indicating for each communication in the portion: the corresponding topic, the topic description associated with the corresponding topic, the communication description associated with the communication, the action indication, and if for action, indicates the end date associated with the action.

In addition, the user interface 901 can provides a save/cancel button 925, so that the communication can be saved for further editing or canceled if desired.

Referring now to FIG. 10, an illustration of one example of a user interface 1001 for finalizing and sending at least one communication, according to one or more embodiments will be discussed and described. In the illustrated embodiment 1001, multiple communications 1005, 1007, 1009, 1011 have been created, and are available to be sent to their respective recipients. The communications displayed on the illustrated user interface 1001 include the first communication 1005, which was described in connection with FIG. 9.

The information provided in the illustrated user interface 1001 for each communication include the topic information 1021 associated with each communication, the communication information 1023 specific to the communication, and envelope information 1019. Envelope information includes the recipient 1013, the author 1017, and the legacy 1015, that is, new, unchanged or revised. Additionally, actions 1025 may be selected with respect to a particular communication, including draft, send, and/or delete. Optionally, a send all indication 1003 is provided to send all of the displayed communications.

Note that communications can remain in a “staging area” until they are ready for release. Communications can be released individually, or as a group, from the staging area.

Note that a ranking indication 1027 is provided for each communication, in the illustration referred to as “priority” (not to be confused with priority assigned to the topic). In the illustrated embodiment, the ranking indication includes a text ranking indication, a numerical ranking indication, and a color ranking indication. The text ranking indication is “!”, “˜” and “↓” for high, medium, and low, respectively. The numerical ranking indication is “(9)” to “(3”). The color ranking indication is red, yellow, or green, for high, medium, and low, respectively. The communications can be sorted, for example, by ranking.

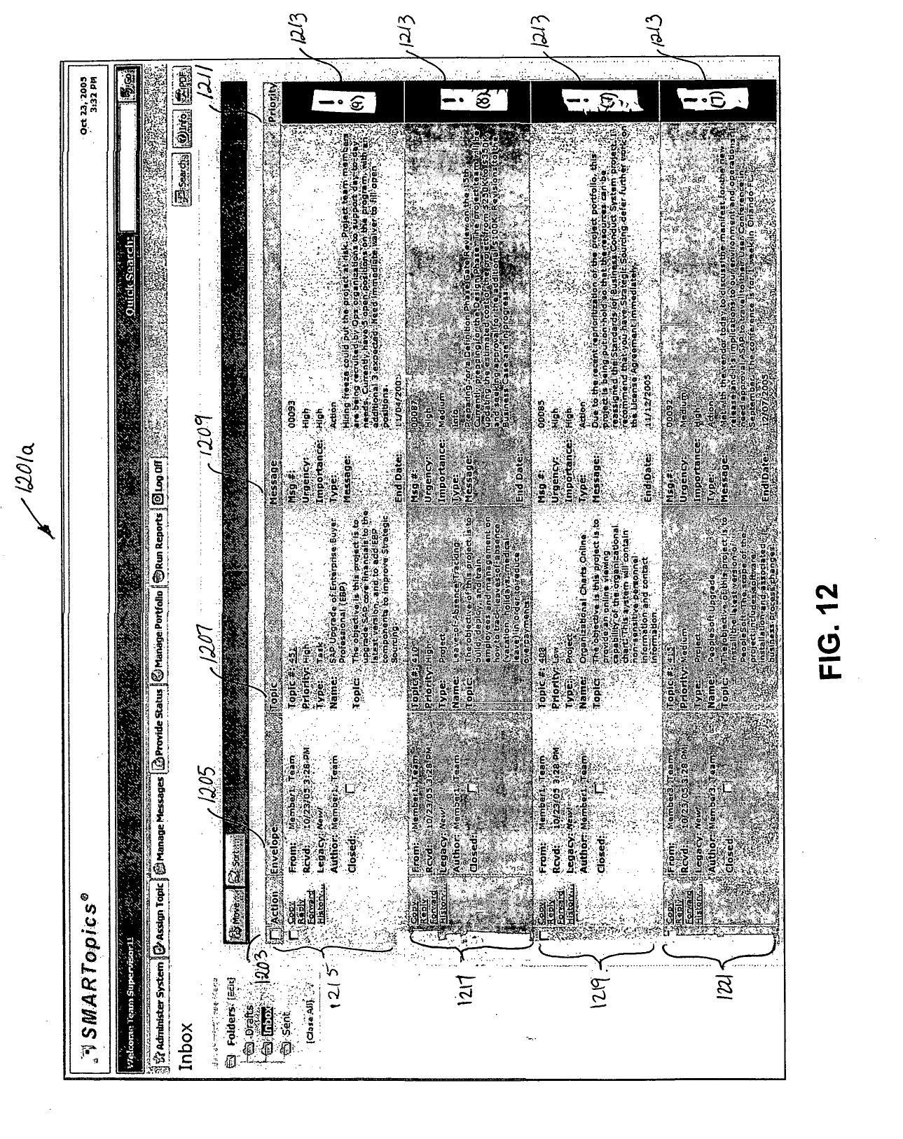

FIG. 11 and FIG. 12-FIG. 14 provide examples of a user accessing alerts relating to active topics and communications which were sent. In FIG. 11, a user can review topic alerts and message alerts. FIG. 12-FIG. 14 together provide an extended screen for a user to access communications in an inbox. A corresponding flow chart is illustrated in FIG. 17.

Referring now to FIG. 11, an illustration of one example of a user interface 1101 for a report on topics and communications, according to one or more embodiments will be discussed and described. In the illustrated user interface 1101, reports (referred to in the illustration as “alerts”) are provided for topics 1103 and communications 1105 (referred to in the illustration as “messages”). In the illustrated user interface 1101, only a portion of information for a topic or communication is displayed.

In the topic alerts 1103, each topic that is displayed includes an indication of “days until” 1107 (days remaining until the end date), an end date indicator 1109, a topic priority indicator 1111, a topic identified 1113, and a topic name 1115. One of the displayed topics can be selected for further action. Also, the illustrated user interface 1101 permits the user to “show all” topics.

In the communication alerts 1105, each communication that is displayed includes an indication of days until 1117, end date 1119, ranking 1121 (referred to in the illustration as “msg priority”), unique message identifier 1123, communication originator 1125, and message 1127. One of the displayed communications can be selected for further action. Also, the user may instruct the illustrated user interface 1101 to “show all” information about the communications. Selecting “show all” can result in a display of all communications, illustrated for example in FIG. 12-FIG. 14.

In the illustrated user interface 1101, the topics and communications that are displayed in the topic alert 1103 and communication alert 1105, respectively are sorted on one of the displayed fields before being displayed. Also, one or more embodiments provide that the number of topics and/or communications displayed is limited, for example, to one screen's worth of information. In this example, the topics have been sorted by priority and the communications have been sorted by ranking.

Referring now to FIG. 12-FIG. 14, an illustration of one example of a user interface 1201a, 1201b, 1201c for accessing received communications according to one or more embodiments will be discussed and described. * In the illustrated embodiment 1201a, 1201b, 1201c, multiple communications 1215, 1217, 1219, 1221, 1223, 1225, 1227, 1229, 1231, 1233, 1235 are displayed on the illustrated user interface 1201a, 1201b, 1201c.

In this example, the information provided in the illustrated user interface 1201a, 1201b, 1201c for each communication includes the envelope information 1205, the topic information 1207, and the communication information 1209. Further, actions 1203 may be selected with respect to a particular communication, including copy, reply, forward, and/or history. The “history” action, when selected, can provide a review of the chain of custody information for the particular communication.

Note that a ranking indication 1211 is provided for each communication, in the illustration referred to as “priority” (not to be confused with priority assigned to the topic). In the illustrated embodiment, the ranking indication includes a text ranking indication, a numerical ranking indication, and a color ranking indication. In the illustrated user interface 1201a, 1201b, 1201c, the communications are sorted by their rankings of high 1213, medium 1301, and low 1302.

Accordingly, one or more embodiments provide that the ranking is represented in a display as particular colors. Accordingly, one or more embodiments provide that the ranking is represented by relative mathematical values.

Because each of the communications is ranked as further described herein, a multiplicity of communications relating to a wide variety of projects can be effectively cross-prioritized in an effective manner. Thereby, even completely unrelated communications can be appropriately ranked so that relative ranking can be readily apparent.

Referring now to FIG. 15, a flow chart illustrating an exemplary procedure for creating and assigning a new topic 1501, in accordance with various embodiments will be discussed and described. The procedure can advantageously be implemented on, for example, a processor of a controller, described in connection with FIG. 3 or other apparatus appropriately arranged. The flow chart illustrated in FIG. 15 can be implemented in connection with user interfaces, for example, those illustrated in FIG. 6 and FIG. 7.

In accordance with the illustrated procedure 1501, the user logs on 1503, for example by entering a user identifier and password and clicking “login.” Then, the procedure 1501 allows the user to select 1505 one of the tabs, for example the “assign topic” tab to direct the system to assign a topic.

The procedure 1501 then can allow the user to select 1507 one of the available projects to which the topic to be created is relevant. In the embodiment of FIG. 15, the project can be selected from a drop-down list of projects which have already been created.

Then, the procedure 1501 can allow the user to complete the information for the topic to be created. For example, the procedure allows the user to add 1509 a unique topic number, which alternatively can be automatically generated; to select the topic type (such as project, task, action item or risk) from a drop-down menu; to add the topic name and description; to select the topic priority (such as high, medium, or low) from a drop-down menu; to indicate a budget; to indicate an action plan (or add a URL link to an action plan); to select a privacy setting (such as local or global); to select an owner (such as from a drop-down list); and to set a start date and end date (such as by a calendar link). Optionally, the procedure 1501 can allow the user, if a topic administrator, can determine whether the topic is active (and therefore available for further user) by clicking “yes” or “no” and then clicking a “save” button.

The procedure 1501 can allow the user to review 1511 the topic that was created to ensure that the data is sufficiently correct. The procedure 1501 can allow the user to revise the data in the topic, for example by clicking “edit.”

The procedure 1501 can check 1513 whether the user wishes to assign another topic, and if so, loop back to allow the user to repeat the foregoing portions 1505, 1507, 1509, 5111. If there are no further topics to be assigned 1513, the procedure 1501 can end processing 1515.

Accordingly, one or more embodiments provides a topic unit, configured to facilitate creating a plurality of topics, including assigning a priority to the topics, the priority being one of a plurality of pre-determined priorities; tasking, responsive to an originator, one of the topics to an owner; assigning a topic description to the topic; and associating the topic with a team including the originator and the owner.

Referring now to FIG. 16, a flow chart illustrating an exemplary procedure 1601 for creating and sending a new communication, in accordance with various embodiments will be discussed and described. The procedure 1601 can advantageously be implemented on, for example, a processor of a controller, described in connection with FIG. 3 or other apparatus appropriately arranged. The procedure 1601 illustrated in FIG. 16 can be implemented in connection with user interfaces, for example, those illustrated in FIG. 8, FIG. 9 and FIG. 10.

In accordance with the illustrated procedure 1601, the user logs on 1603, for example by entering a user identifier and password and clicking “login.” Then, the procedure 1601 allows the user to select 1605 one of the tabs, for example the “provide status” tab.

The procedure 1601 then can allow the user to select 1607 one of the available topics from those to which the user has access. The topic will be relevant to the communication that is to be created. The topic can be selected by clicking “select” for that topic.

Then, the procedure 1601 allows the user to confirm 1609 the default recipient (such as a project manager assigned to the associated topic); to change a recipient by clicking “change;” to write a message to be communicated to the recipient; to select the type of action for the communication (such as “information” or “action”); to set the “end date” for the communication, if the communication has an action type of “action; to select the urgency and importance to be associated with the communication (such as from respective drop-down menus); and to click the “save” button when the communication is complete.

The procedure 1601 further allows the user to review the communication in a “message staging area” to ensure that the data is complete and accurate. A communication can be revised responsive to the user by allowing the user to click “edit.” The procedure can check whether the user wishes to write 1613 another communication, and if so, to repeat the process described above 1605, 1607, 1609, 1611.

The procedure 1601 can then allow the user to manage 1615 one or more communications by keeping the communication(s) as a draft for later editing, or by finalizing the communication(s) by clicking “finalize.”

Next, the procedure 1601 can allow the user to send 1617 the finalized communications by selecting the “send” button. Processing for the procedure 1601 can then end 1619. Note that communications can remain in the staging area until the user is prepared to release them.

Accordingly, one or more embodiments provides a communication production unit, configured to facilitate producing a plurality of communication, including at least one communication, the at least one communication being initiated by a member of the team and associated with one of the topics; producing the communication further including assigning the at least one communication one of a plurality of pre-determined urgencies reflecting a deadline and one of a plurality of pre-determined importances, the urgency and importance being responsive to the team member, automatically associating the at least one communication with the priority assigned to the topic, associating the at least one communication with a communication description, the communication description for the communication being limited to less than a pre-determined limited character length, associating the at least one communication with an action indication whether the at least one communication is for information or for action, and if for action, indicating an end date associated with the action; and automatically routing the at least one communication to the owner.

Referring now to FIG. 17, a flow chart illustrating an exemplary procedure 1701 for a user to access alerts and communications in accordance with various embodiments will be discussed and described. The procedure 1701 can advantageously be implemented on, for example, a processor of a controller, described in connection with FIG. 3 or other apparatus appropriately arranged. The procedure illustrated in FIG. 17 can be implemented in connection with user interfaces, for example, those illustrated in FIG. 11 and FIG. 12-14.

As previously described, one or more embodiments can provide for a user to receive a notification, such as an e-mail, indicating that a communication has been received. Accordingly, the procedure 1701 can provide for after receiving an e-mail alert 1703 indicating that communications (and optionally topics) have been received, a user (the recipient of the communications) can log in. A log in can be accomplished, for example, by entering a user identification and password, and clicking “login.”

The procedure 1701 can provide for the user (recipient) to review 1705 the topic alerts and/or communication alerts. In the illustrated embodiment and corresponding illustrated user interface, the alerts can indicate a number of “days until end date.”

Then, the procedure 1701 can provide for the user (recipient) to select 1707 the “inbox,” such as from a file structure, to review the received communications. Further, the procedure 1701 can provide for the user (recipient) to review 1709 the inbox, which contains the communications. The communications in the inbox are standardized in accordance with the discussion herein, and are ranked, which provides in other words a cross-prioritization for comparison against other communications.

The, the procedure 1701 can provide for the user (recipient) to review 1711 a communication, associated topic information, and associated envelope information. The procedure also can allow the user (recipient) to copy, reply, and/or forward the communication and/or to check the history of the communication by clicking a respective link. Also, the user (recipient) can close the communication by checking the respective “close” box in the envelope portion of the user interface.

The procedure 1701 can check whether the user wishes to read 1717 another communication, and if so, to repeat the process described above 1705, 1707, 1709, 1711, 1713, 1715. Processing for the procedure 1701 can then end 1719.

The look and feel presented in the exemplary user interfaces described herein can be intuitive, and can incorporate features which are similar to e-mail interfaces.

It will be appreciated that role-based administration can advantageously be incorporated into one or more embodiments. For example, one or more embodiments can provide for regular users and administrators. One or more of the users can be assigned as a regular user; regular users can perform any action possible for a communication, can review topics for which they are associated as a user, and can perform reports for which they are associated with as a user. One or more of the users can be assigned as an administrator; an administrator can perform all of the permitted actions for a regular user, can add users, can assign users to teams, can perform any action possible for a topic, and can perform any report for any or all users.

User interfaces may be developed, for example, in connection with an HTML display format. It is possible to utilize alternative technology for displaying information, obtaining user instructions and for providing user interfaces. One or more embodiments can use the Internet as an interface with the user.

One or more embodiments may be utilized in connection with a general purpose computer, a specially programmed special purpose computer, a personal computer, a distributed computer system, calculators, handheld, laptop/notebook, mini, mainframe, and super computers, as well as networked combinations of the same.

One or more embodiments may rely on the integration of various components including, as appropriate and/or if desired, hardware and software servers, database engines, and/or other content providers. One or more embodiments may be connected over a network, for example the Internet, an intranet, or even on a single computer system. Moreover, portions can be distributed over one or more computers, and some functions may be distributed to other hardware, in accordance with one or more embodiments.

Further, portions of various embodiments can be provided in any appropriate electronic format, including, for example, provided over a communication line as electronic signals, provided on floppy disk, provided on CD Rom, provided on optical disk memory, etc.

Any presently available or future developed computer software language and/or hardware components can be employed in various embodiments. For example, at least some of the functionality discussed above could be implemented using Visual Basic, C, C++, Java or any assembly language appropriate in view of the processor being used.

One or more embodiments can store collected information in a database. An appropriate database may be on a standard server. The database optionally is distributed and/or networked.

One or more embodiments may include a process and/or steps. Where steps are indicated, they may be performed in any order, unless expressly and necessarily limited to a particular order. Steps that are not so limited may be performed in any order.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A computer system for managing workflow information, the workflow relating to a topic shared among a team of users, comprising:
a creation unit, configured to facilitate creating a plurality of topics, including assigning a priority to each of the topics;
a topic assignment unit, configured to facilitate tasking, responsive to an originator, a topic to an owner, and associating the topic with a team, the owner and the originator being members of the team; and
a communication production unit, configured to facilitate producing a plurality of communications, including at least one communication, responsive to the topic and automatically associated with the topic, the at least one communication being initiated by a team member, and being assigned an urgency reflecting a deadline and an importance selected by the team member, and automatically associated with the priority assigned to the topic,
wherein the priority is one of a plurality of pre-determined priorities, the urgency is one of a plurality of pre-determined urgencies, and the importance is one of a plurality of pre-determined importances,
wherein a ranking of the at least one communication relative to communications in the plurality of communications can be automatically calculated, in the computer, from a combination of the priority, the urgency, and the importance.

2. The computer system of claim 1, wherein the topic is a project, a task, an action item, or a risk.

3. The computer system of claim 1, further comprising a ranking unit, configured to facilitate the ranking of a portion of the communications in the plurality of communications responsive to a request, wherein the communications in the portion are associated with at least one team, at least one owner, at least one originator, or at least one topic specified in the request.

4. The computer system of claim 1, wherein there are three pre-determined priorities, three pre-determined urgencies, and three pre-determined importances.

5. The computer system of claim 1, further comprising a report unit configured to facilitate preparing a report of communications responsive to a request, including the ranking of a portion of the communications in the plurality of communications, and providing the report including information representative of the communications and topics in the portion and the ranking of the communications,
wherein the communications in the portion are associated with at least one team, at least one owner, at least one originator, or at least one topic specified in the request.

6. A computer-readable medium comprising instructions for execution by a computer, the instructions including a computer-implemented method for managing communications related to status of a plurality of topics, the instructions for implementing:
accessing a plurality of communications, each communication having an urgency reflecting a deadline, an importance, and a priority, the priority being inherited from a corresponding topic of a plurality of topics, wherein the priority is one of a plurality of pre-determined priorities, the urgency is one of a plurality of pre-determined urgencies, and the importance is one of a plurality of pre-determined importances, each communication being associated with the corresponding topic, and each communication being associated with a communication originator; each topic being associated with an owner, a team, and a topic originator and having a priority assigned thereto;
automatically ranking a portion of the communications by determining a combination of the priority, the urgency, and the importance associated with each communication in the portion, and associating the ranking with each communication in the portion; and
providing a summary of the communications in the portion and an indication of the ranking associated with each communication in the portion.

7. The computer-readable medium of claim 6, further comprising instructions for implementing creating the plurality of topics, including entering, responsive to a user, a description of the topic; assigning, responsive to the user, the priority to the topic; assigning, responsive to the user, an owner of the topic; assigning a team to the topic; and automatically assigning the user as the originator of the topic; wherein the owner and the user are members of the team; and
automatically routing, responsive to the creating, the topic to the owner.

8. The computer-readable medium of claim 6, further comprising instructions for receiving a communication associated with the topic, responsive to creation of the communication.

9. The computer-readable medium of claim 6, further comprising instructions for searching the plurality of communications by topic, priority, urgency, importance, or ranking.

10. The computer-readable medium of claim 6,
wherein each topic is associated with a topic description;
wherein each communication is associated with a communication description, the communication description for the communication having less than a pre-determined limited character length;
wherein each communication includes an action indication whether the communication is for information or for action, and if for action, indicates an end date associated with the action;
wherein the instructions for providing the summary of the communications in the portion further include indicating for each communication in the portion: the corresponding topic, the topic description associated with the corresponding topic, the communication description associated with the communication, the action indication, and if for action, indicates the end date associated with the action.

11. A computerized method of distributing, communicating, and/or reporting topics shared among users, comprising:
creating a plurality of topics including a topic, including assigning a priority to the topic, associating the topic with a team of users, and tasking the topic to an owner, the owner being one of the users of the team; and
producing a plurality of communications responsive to the topic, each of the communications being initiated responsive to a user of the team and being assigned, at least one of manually and semi-automatically responsive to the user, an urgency representative of a time for completion and an importance, the communication being automatically assigned the priority assigned to the topic,
wherein the priority is one of a plurality of pre-determined priorities, the urgency is one of a plurality of pre-determined urgencies, and the importance is one of a plurality of pre-determined importances.

12. The method of claim 11, further comprising ranking the communication relative to other communications in the plurality of communications, responsive to the priority, urgency and importance.

13. The method of claim 12, further comprising reporting on the plurality of communications by the ranking, the report further being limited to communications responsive to at least one of owner, originator, team and topic.

14. The method of claim 12, wherein the ranking is represented in a display as particular colors.

15. The method of claim 12, wherein the ranking is represented by relative mathematical values.

16. The method of claim 11, further comprising searching the plurality of communications by priority, urgency, importance, and at least one of keyword, owner, and originator.

17. The method of claim 11, the priority, urgency, and importance each comprising high, medium and low values.

18. The method of claim 11, further comprising associating an end date with at least one of the at least one topic and the at least one communication, wherein the urgency is further responsive to the end date.

19. The method of claim 11, wherein the at least one communication includes a chain of custody indicative of originators and intervening recipients associated with the at least one communication.

20. The method of claim 11, further comprising
automatically routing, in the computer, the at least one topic to the owner, responsive to the creating of the at least one topic; and
automatically routing, in the computer, the communication to the owner.

21. A computer system for managing communications related to status of a plurality of topics, comprising:
a topic unit, configured to facilitate creating a plurality of topics, including assigning a priority to the topics, the priority being one of a plurality of pre-determined priorities; tasking, responsive to an originator, one of the topics to an owner; assigning a topic description to the topic; and associating the topic with a team including the originator and the owner;
a communication production unit, configured to facilitate producing a plurality of communications, including at least one communication, the at least one communication being initiated by a member of the team and associated with one of the topics; producing the communication further including assigning the at least one communication one of a plurality of pre-determined urgencies reflecting a deadline and one of a plurality of pre-determined importances, the urgency and importance being responsive to the team member, automatically associating the at least one communication with the priority assigned to the topic, associating the at least one communication with a communication description, the communication description for the communication being limited to less than a pre-determined limited character length, associating the at least one communication with an action indication whether the at least one communication is for information or for action, and if for action, indicating an end date associated with the action; and automatically routing the at least one communication to the owner.
a communication reception unit associated with a particular user, the particular user being a member of the team, configured to facilitate receiving the at least one communication associated with topics associated with the team;
a ranking unit, configured to facilitate ranking a portion of the communications by automatically calculating a value for each communication in the portion from an equally-weighted combination of the priority, the urgency, and the importance associated with each communication, the value indicating a rank of each communication in comparison to other communications; and associating the rank with each communication in the portion; and
a report unit, configured to facilitate providing a report, responsive to a user, of communications for which the user is a team member of the associated topic, including an indication for each communication in the portion of: the corresponding topic, the topic description associated with the corresponding topic, the communication description associated with the communication, the action indication, and if for action, the end date associated with the action;
wherein there are three pre-determined priorities, three pre-determined urgencies, and three pre-determined importances.
